(19) United States
(12) Patent Application Publication
(10) Pub. No.: US 2010/0299319 A1
(43) Pub. Date: Nov. 25, 2010

(54) METHOD, APPARATUS, AND ARCHITECTURE FOR AUTOMATED INTERACTION BETWEEN SUBSCRIBERS AND ENTITIES

(75) Inventors: Dale E. Parson, Fleetwood, PA (US); C. John Glossner, Carmel, NY (US); Sanjay Jinturkar, Basking Ridge, NJ (US)

Correspondence Address: BARNES & THORNBURG LLP, 750-17TH STREET NW, SUITE 900, WASHINGTON, DC, 20006-4675, US

(73) Assignee: SANDBRIDGE TECHNOLOGIES, INC., Tarrytown, NY (US)

(21) Appl. No.: 12/373,028

(22) PCT Filed: Feb. 13, 2008
(86) PCT No.: PCT/US2008/053833

§ 371 Date: Aug. 6, 2010

Related U.S. Application Data
(60) Provisional application No. 60/969,245, filed on Aug. 31, 2007.

(51) Int. Cl. G06F 17/30

(52) U.S. Cl. 707/713; 707/E17.017

(57) ABSTRACT

A method for interaction between a subscriber and an entity includes determining a current locus and acquiring change in status information for a subscriber. Preference information, for one or more searchable parameters selected by the subscriber, and association information, for one ore more contacts made by the subscriber, are acquired. First and second strength information is then acquired. First strength information pertains to the subscriber's affinity for the preference information and second strength information encompasses the subscriber's affinity for the association information. Responsive to the change in status information, a group of first entities is selected. First entity information about the group of first entities is then generated. The current locus information, the preference information, the association information, the first strength information, and the second strength information are correlated with the first entity information to produce correlation information. Finally, the correlation information is provided to the subscriber to be displayed.

### CROSS-REFERENCE TO RELATED APPLICATIONS

This is a National Stage United States Patent Application that relies for priority on PCT Patent Application No. PCT/US2008/53833, which was filed on Feb. 13, 2008, the contents of which are incorporated herein by reference. This United States Non-Provisional Patent Application also relies for priority on U.S. Provisional Patent Application Ser. No. 60/969,245, filed on Aug. 31, 2007, entitled “Method, Apparatus, and Architecture for Automatically Finding Communication Contacts and Services Based on Location and Movement of Mobile Subscribers,” the contents of which also are incorporated herein by reference.

### FIELD OF THE INVENTION

The present invention relates generally to automatically searching a distributed database on a user's behalf, to displaying the search results, and to learning from a user's reaction to displayed results. The invention relates more particularly to a method, apparatus and architecture that apply such techniques for finding, proposing, recording, and analyzing communication contacts with other users of interest to a mobile user who is entering, leaving, or moving within a physical or virtual space of locales.

### BACKGROUND OF THE INVENTION

Today, people use distributed databases on communication networks such as the Internet by querying them from computers, mobile phones, personal digital assistants and other so-called “client terminal devices.” An ad hoc textual search supplies keywords to a search engine. A more structured database search usually requires filling out some forms that generate a query language exchange of information. Both types of interaction require a user to instigate and refine search via queries.

As may be appreciated by those skilled in the art, these approaches are limiting in that the user must initiate a query to obtain information of interest.

### SUMMARY OF THE INVENTION

An alternative approach given by the present invention allows mobile users (both people and establishments) to subscribe to a service that drives the search for them, delivering interesting information to their mobile phones and computers as this information becomes available and locationally relevant. Instead of a query, subscriber motion triggers automatic search through pertinent data. When a subscriber moves into a geographic or virtual space where there is useful information about other people, establishments, products or their services, then the present invention delivers the information to the subscriber according to his or her level of interest.

The present invention also delivers information about relevant arriving or departing subscribers to local establishments and other interested subscribers unless the former have blocked visibility of their information from potential receiving subscribers.

The present invention determines importance of locationally relevant information based on past associations and habitual preferences stored in explicit subscriber profiles, or by learning associations and preferences by automatically (i.e., without subscriber intervention) analyzing repeated subscriber interactions.

The present invention adapts to the changing likes, dislikes and habits of its mobile subscribers, and it helps these subscribers adapt to their changing settings.

The present invention differs from other available social networking services and location based services in several important ways. On-line social networking services such as MySpace (http://www.myspace.com/) and Facebook (http://www.facebook.com/) offer direct, associative links between subscribers, as well as property-value and keyword data tags that subscribers can attach to their profiles to describe and to distinguish themselves. Subscribers can interactively browse and search for subscribers of interest, using these links and data tags to guide interaction. GPS-based Location-oriented services allow subscribers to track the locations of friends interactively (e.g., Mologogo, http://www.mologogo.com/), to search explicitly for products and services based on product name, price, and GPS-supplied location data (e.g., GPShopper, http://www.gpshopper.com/; Slifter, http://www.slifter.com/), and to get directions and to search for other commercial and non-commercial geographic data relevant to GPS-enabled mobile device users (Where™, http://www.where.com; Microsoft Live Search, http://www.microsoft.com/windowsmobile/livesearch/default.mspx). The present invention differs from such services in several ways.

The present invention eliminates the need for mobile subscribers and their potential contacts to perform explicit, interactive browse and query actions to find other subscribers of interest. The inference mechanisms of the current invention automatically perform browsing and searching on subscribers' behalf, triggered by movement of one or more subscribers in one or more locational spaces. This capability is especially important in mobile situations where a subscriber may be driving a car or engaging in other mobile activity requiring full attention. It also saves time and effort in other mobile situations.

Locational space used by the present invention is not limited to one space such as GPS-enabled or wireless-access-beacon-located geographic space. It can include subscriber movement in geographic space, virtual URL space on the Word Wide Web, virtual health space, and other possible application-oriented spaces.

A given subscriber can use multiple mobile devices in multiple mobile spaces at one time within the present invention.

In the present invention a subscriber's interaction with a given space can be either global or hidden. For example, global geographic space is shared by all subscribers with devices operating in that geographic space, although actual visibility of one subscriber to others in a shared space is limited by permissions and blocking data tags set by the subscriber. A global space makes it possible to find new people and establishments while moving. A hidden space, in contrast, connects only a set of subscribers circumscribed by the subscriber using the hidden space. A hidden health monitoring space that informs only circumscribed friends and medical emergency services of a subscriber's movement into a deteriorating health condition is an example use of a hidden space.

The present invention presents potential contact information to subscribers based on historical level of interest, where level of interest has been set explicitly in a subscriber profile or learned by the present invention using statistical monitoring mechanisms.

The present invention uses statistical monitoring mechanisms to learn new associations to other subscribers automatically, based on subscriber communication actions.

The present invention uses statistical monitoring mechanisms to learn new preferences for other subscribers tagged with keyword combinations automatically, based on subscriber communication actions.

The present invention uses statistical monitoring mechanisms to learn new preferences for other subscribers with specific spatial relations automatically, based on subscriber communication actions.

The learning mechanisms customize the service of the present invention to each subscriber's usage habits. The present invention provides mechanisms that could extend and enhance other existing social networking and location based services such as those listed above.

A service distributed over one or more communication networks assists mobile subscribers by performing automated queries on their behalf to locate other subscribers or services of interest in their respective locales, and by providing communication contact information to mutually interested subscribers within a locale. A subscriber is a person, establishment, piece of property, or other subscribing entity, or a collection of such entities, which possesses mobile capabilities and communication capabilities. A mobile capability is the ability to move in one or more physical or virtual spaces, or a subscriber's interest in such movement by other subscribers. A communication capability is the ability to communicate with other subscribers via means including but not limited to telephone networks, computer communications networks, and direct physical interaction. A subscriber may offer commercial or non-commercial services to other subscribers via the communication capability of the present invention.

The present invention uses two mechanisms that are stored in a distributed database to help a mobile subscriber find local subscribers of interest.

The first mechanism, an association, is a link that connects a subscriber to another subscriber with whom the first subscriber has had previous communications, as recorded in a database. When a mobile subscriber moves into a locale, the present invention follows associations out from this originating mobile subscriber in one or more transitive steps, subsequently following associations from other subscribers thus found, in order to find subscribers in the originating subscriber's locale. A strength tagged to each association gives its originator's level of interest, and this level diminishes as the present invention crosses multiple associations in an acyclic path.

The second mechanism, a preference, is a database query formula containing textual keywords that are optionally connected by logical query operators such as ‘and,’ ‘or,’ ‘minus’ and ‘not.’ Each subscriber has a database record that includes a collection of keywords tagged to that subscriber record. When a mobile subscriber moves into a locale, the present invention uses the subscriber's preference formulae to query a database for that locale in order to find subscriber records tagged with those logical combinations of keywords in that locale. A strength tagged to each preference gives its originator's level of interest. The present invention presents a mobile user with a list of prospective subscribers and their advertised services to contact within the locale, sorted by strength and classified by keywords tagged to those subscribers' records. The present invention also notifies the latter subscribers of the arrival of the mobile subscriber.

The present invention records in its database prospective contacts displayed to subscribers as well as actual contacts made by subscribers as the basis for statistical strengthening of used and weakening of unused associations and preferences. Subscribers can explicitly enter associations, preferences and their strengths into the service's database. The present invention also learns new associations established by new subscriber-to-subscriber contacts, and it learns new preferences by analysis of keywords that are strongly correlated with subscribers that are the targets of high-strength associations.

The present invention may track movement of a subscriber in one or more physical or virtual spaces, including but not limited to: 1) geographic space monitored by the Global Positioning System, or by wireless access beacons (e.g., 802.11a/b/g, Bluetooth®, Global Systems for Mobile Communications (GSM), or others) with known physical locations, or by direct user entry of location data into a mobile device, or by direct or wireless connection of a mobile device to a communications device with a known physical location, or by other means, 2) Universal Resource Locator space on the World Wide Web, 3) health space such as the movement from a healthy to an emergency condition for a subscriber with a health monitor, and 4) other possible application-oriented locational spaces. All mechanisms in the present invention can include permissions that prohibit or allow dissemination of a subscriber's information to other subscribers or classes of subscribers.

The present invention operates as a service distributed over one or more communication networks such as the Internet and/or cellular telephone networks, wired telephone networks, or other networks. It comprises client software mechanisms that execute on one or more client devices, such as personal computers, cellular telephone handsets, personal digital assistants, or dedicated medical monitoring devices, in communication with server software mechanisms that execute on one or more server computers. These server software mechanisms search a distributed database for communication contact information of interest to client subscribers when those subscribers' client devices notify the server software of client movement within and between physical or virtual locales.

Client devices may include hardware or software that monitors client movements, such as: (1) Global Positioning System (GPS) hardware and software for tracking device movement in physical space, (2) translation of wireless network access point (e.g., 802.11, Bluetooth®, GSM, or similar) identifiers to the physical locations of those access points, (3) direct user entry of location data into a mobile device, (4) direct or wireless connection of a mobile device to a communications device with a known physical location, (5) address recognition software for tracking movement within the World Wide Web's Universal Resource Locator (URL) address space, (6) dedicated medical monitoring hardware for tracking movement of a client subscriber's health within a virtual health space, or other possible application-oriented devices and spaces.

A device capable of automatically tracking client movement within a space reports that movement to server software mechanisms, thereby initiating search within the server's distributed database. A client subscriber also may explicitly send movement information via data entry in a client device to server software mechanisms.

Server software mechanisms maintain several types of records in a distributed database. Each subscriber to a service embodying the present invention has a subscriber record. A subscriber record has a unique database identifier (DBID). A subscriber record also has a field that records each device assigned to that subscriber. A device also has a unique DBID; it resides and may move in one of physical or virtual space. The subscriber record maintains a history of at least the two most recent locations (when available) in the physical or virtual space most recently occupied by that device. When a client device moves, it notifies the server software of its subscriber DBID, its own device DBID, the type of space in which it has moved, its new coordinates within that space, and its time of entry into that location. This subscriber's record stores the new location of the device in its location list for that device in chronological order. The server software mechanisms then search for other subscribers in the locale of the device with whom the mobile subscriber would normally be interested in establishing contact.

Each subscriber record maintains a list of zero or more DBIDs that identify associations leading from this owning subscriber to another subscriber with whom the first subscriber has had previous communications, as recorded in the server's database. The movement of a client subscriber's device triggers the server's examination of the subscriber's record's list of associations. Each association has a destination subscriber DBID and a numeric strength, and the server crosses associations in order of strength. Each association is tagged with proximity constraints such as “inside” or “near,” as well as movement constraints such as “move into” or “move near” that give relative proximity and relative movement between two subscribers respectively. When the originating mobile subscriber satisfies at least one proximity or movement constraint for an association leading to another subscriber, the DBID of the other subscriber enters two sets, the set of subscribers receiving notification of the originating mobile subscriber's presence (the so-called “consumed set”), and the set of subscribers whose DBIDs and contact information return to the originating subscriber (the so-called “returned set).

The server's search mechanism (a.k.a. the inference mechanism) crosses associations in one or more transitive steps, creating acyclic paths from the originating subscriber to local subscribers whose locations satisfy association proximity or movement constraints relative to the originating subscriber. Transitive association crossing effectively borrows associations from intermediate subscribers along an acyclic path, even though those intermediate subscribers may not have locations that satisfy proximity or movement constraints. An example is when a mobile subscriber uses a “friend of a friend” transitive association, first crossing a “friend” association to find a friend subscriber who is not within proximity as constrained by the association, followed by following a “friend” association out of that subscriber to a third subscriber, the “friend of a friend,” whose location is within the proximity or movement constraints specified by the latter association. The server's inference mechanism places the DBID of this “friend of a friend” into the consumed set and returned set of the originating subscriber, albeit at a weakened, transitive strength determined, by applying some mathematical formula to combine the strengths of the two transitive associations used to reach this “friend of a friend.”

Each subscriber record also maintains a list of zero or more DBIDs that identify preferences leading from this owning subscriber to keywords that are tagged to subscriber records in the database. The movement of a client subscriber's device triggers the server's examination of the subscriber's record's list of preferences. Each preference has a keyword query formula and a numeric strength, and the server crosses preferences in order of strength. A preference's keyword formula contains textual keywords that are optionally connected by logical query operators such as ‘and,’ ‘or,’ ‘minus’ and ‘not’. Each subscriber's database record includes a collection of keywords tagged to that subscriber. When a mobile subscriber moves into a locale, the server uses the subscriber's preference formulae to query a database for that locale in order to find DBIDs for subscribers tagged with those logical combinations of keywords in that locale. Each preference is tagged with proximity constraints such as “inside” or “near,” as well as movement constraints such as “move into” or “move near” that give relative proximity and relative movement between two subscribers respectively.

When the originating mobile subscriber satisfies at least one proximity or movement constraint for a preference query leading to another subscriber, the DBID of the other subscriber enters the so-called “consumed set” and the so-called “returned set” as defined above. An example of a preference is a query formula for “Italian and food.” When the device of a mobile subscriber with this preference reports entry into a locale to the server, the server's inference mechanism queries the database in the device's locale for all subscribers tagged with the keywords “Italian” and “food.” Preference-based keyword search leads to zero or more subscribers in a locale via combinations of keywords.

It is possible to limit the target subscribers reached via inference across a preference to a specific subtype of subscribers, such as establishments, or people, or property, by tagging a subscriber subtype constraint onto the preference. Such a tagged preference adds to the “consumed set” and “returned set” only target subscribers of the specified subtype.

The server's inference mechanism collects DBIDs for subscribers into the “consumed set” and the “returned set” until one of two things happens. Either the server finds as many subscribers (e.g., people and/or establishments) DBIDs as requested by the originating mobile subscriber's device, or the server runs out of candidate subscribers, exhausting the search. The server maintains the state of its search, so that if the client device requests additional subscriber DBIDs in the locale, the server's inference mechanism can resume where it left off. The server resets search state and restarts the inference mechanism when a client device reports movement into a new locale or after some user-determined elapse of time. The server maintains search state for each device reporting movement for a subscriber.

The server returns to the mobile device a list of prospective subscribers to contact within the locale, sorted by strength and classified by keywords tagged to those subscribers, as determined by the “returned set.” The server also notifies the devices of the latter subscribers, establishments, and/or services, who reside in the “consumed set,” of the arrival of the mobile subscriber. The reason that there are two distinct sets is that subscriber records, associations and preferences can block flow of information about a mobile subscriber to other subscribers (so-called “outgoing blocks”), and independently block the return of information about other subscribers to an originating mobile subscriber (so-called “incoming blocks”). Each block can be a specific subscriber DBID, with the blocked subscriber having that DBID, or the block can be a keyword formula, with blocked subscribers satisfying that formula. Blocks may either block explicitly identified subscribers (e.g., block all subscribers in this set of DBIDs), or they may explicitly allow only the stated subscribers (e.g., block all subscribers not in this set of DBIDs). The “outgoing blocks” place restrictions on target subscriber DBIDs going into the “consumed set,” and the “incoming blocks” place restrictions on target subscriber DBIDs going into the “returned set.”

For a subscriber who is a potential target (a.k.a. consumer) of a moving subscriber's inference, the roles of blocks are reversed; the target subscriber's “outgoing blocks” place restrictions on the target's DBID going into the moving subscriber's “returned set,” and the target subscriber's “incoming blocks” place restrictions on the target's DBID going into the moving subscriber's “consumed set.' The “outgoing blocks” help maintain privacy for a subscriber, and the “incoming blocks” reduce information overload. A subscriber can also limit permissions for other subscribers who are permitted to use an association or preference coming out of that subscriber to a value of all, none, or an explicit list of subscriber DBIDs.

The server stores in its database prospective contacts displayed to subscribers as well as actual contacts made by subscribers as the basis for statistical strengthening of used and weakening of unused associations and preferences. Subscribers can explicitly enter associations, preferences and their strengths into the service's database. The server also learns new associations established by new subscriber-to-subscriber contacts, and it learns new preferences by analysis of keywords that are strongly correlated with subscribers that are the targets of high-strength associations.

The server can track and respond to movement of client subscriber devices in one or more physical and/or virtual spaces, including geographic space monitored by the Global Positioning System or other means, Universal Resource Locator space on the World Wide Web, health space such as the movement from a healthy to an emergency condition for a subscriber with a health monitor, and other possible application-oriented locational spaces.

Other aspects of the invention will be made apparent from the discussion that follows and the drawings appended hereto.

### BRIEF DESCRIPTION OF THE DRAWINGS

Various aspects of the invention will now be described in connection with the drawings appended hereto.

FIG. 1 is a class diagram showing mandatory and optional data fields in the software classes Subscriber, Association, Preference and ContainerPreference, relationships for classes Person, Establishment and Property derived from Subscriber, and class LocationServer derived from Establishment. A hollow arrow denotes object-oriented inheritance of class properties, with the arrow pointing from a derived class or classes to a base class. A solid arrow denotes use or reference of one class by another, where the destination of the arrow is the used or referenced class.

FIG. 2 is a class diagram showing abstract class LocationAPI that declares a number of abstract operations (shown in italics) for concrete derived classes that define application-oriented location spaces for Subscriber movement. LocationAPI also defines a number of concrete functions (shown in regular font) for manipulating containment trees of concrete derived class objects, along with other concrete properties shared by all classes derived from LocationAPI. FIG. 2 also shows six exemplary concrete classes, derived from LocationAPI, each of which represents an application-oriented type of locational space, namely, GeographicLocation, URLLocation, HealthLocation, TemporalLocation, AlarmLocation, and RectangleLocation.

FIG. 3 shows the functions and data fields of the Activation class that records the progress of automatic database search (a.k.a. inference) after a Subscriber device moves in a locational space and reports that move to a server process.

FIG. 4 is an object diagram, illustrating a first case example of the present invention in use.

FIG. 5 is an object diagram, illustrating a second case example of the present invention in use.

FIG. 6 is an object diagram, illustrating a third case example of the present invention in use.

FIG. 7 is an object diagram, illustrating a fourth case example of the present invention in use.

FIG. 8 is a flow diagram outlining one embodiment of the invention.

FIG. 9 is a first part of a flow diagram providing the operations that are encompassed by at least one of the methods of the invention.

FIG. 10 is a second part of a flow diagram, continued from FIG. 9, providing the operations that are encompassed by at least one of the methods of the invention.

### DESCRIPTION OF PREFERRED EMBODIMENT(S) OF THE INVENTION

As should be apparent to those skilled in the art after reading the discussion that follows, there are variations and equivalents to the embodiments described herein that are too numerous to discuss in connection with the invention. Those equivalents and variations are intended to fall within the scope of the invention. In other words, the invention is not intended to be limited solely to the embodiments described herein.

For ease of reference, this disclosure is divided into the following sections: (I) Subscribers, Associations, Preferences and Locations; (II) Automatic Search and Subscriber Activation; (III) Statistical Learning, and (IV) Example Use Cases. While provided for ease of reference, these headings are not intended to be limiting of the scope of the discussions thereunder.

### I. Subscribers, Associations, Preferences and Locations

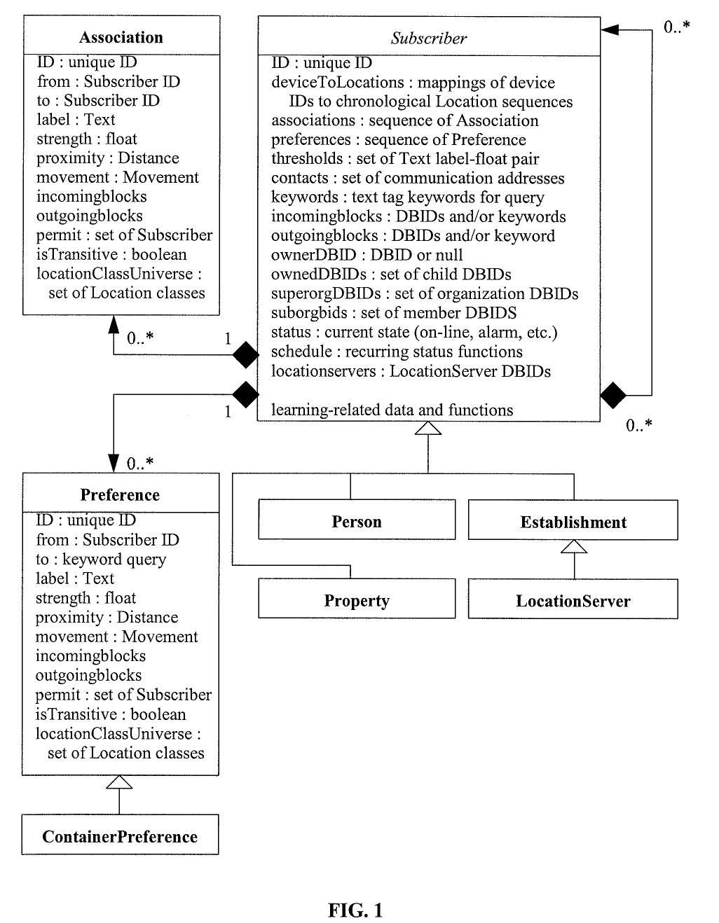

FIG. 1 provides a class diagram for a Subscriber and its subclasses. In addition FIG. 1 provides a graphical illustration of Association, Preference and ContainerPreference information. This class diagram represents an exemplary implementation of the present invention using an object-oriented software programming paradigm.

A particular Subscriber is an object that initiates associative inference when it moves into a geographic area, or into an area in a non-geographic, virtual locational space where the Subscriber has Associations with other Subscribers in that area or Preferences leading it to other Subscribers. The Subscriber also may initiate associative inference(s) if it reacts to another Subscriber's associative inference Activation that reaches this Subscriber in the associative inference network; if the other Subscriber has not blocked this Subscriber from being activated, then this Subscriber will be notified.

The three types of Subscriber properties are class-identifier pairs, predefined attribute-value pairs, and data-defined, extensible keyword tags. The three primary derived concrete classes in FIG. 1 are Person, Property and Establishment. Subscriber is the common base class for these three classes. It defines all of their fields and operations, but it is an abstract class, never being instantiated by the object system as a concrete object. The bold and italic font styles denote concrete and abstract classes respectively. A particular object's ID (identifier) is the value part of its class-ID pair, a.k.a. its DBID (database identifier).

Concrete class LocationServer, derived from Establishment, represents a server that provides query support for Preference matching. When a mobile user moves into a new locational area, that user also moves into the locale of a nearby LocationServer. Client device interactions with this exemplary implementation of the present invention occur via a server process at the user's LocationServer. A LocationServer is, thus, a special-purpose Establishment that implements the server process in conjunction with other networked LocationServers. LocationServer adds additional fields and functions to support automated inference and learning of the present invention.

The diamond-headed containment link on the right side of FIG. 1 shows that a given Subscriber can own zero or more Subscribers, and that a given Subscriber can be owned by or belong to zero or more superordinate Subscribers. Membership is a special form of Association that supports hierarchical organizations that may be distributed physically, such as chain stores, civic groups, social clubs, and so on. It also supports ownership of Property by a Person, or distribution of a piece of Property. Membership forms a hierarchical directed-acyclic-graph (DAG) rather than a tree, since a Subscriber can belong to zero or more Subscribers. There is a special case of membership, ownership, where a Subscriber's owner is optional and unique if present, and the owner determines a unique set of owned Subscribers. Ownership is aimed at commercial entities such as chain stores, as well as owned Property. Subscriber fields, including ownerDBID, ownedDBIDs, superorgDBIDs and suborgDBIDs, etc., in FIG. 1, provide access to membership hierarchies. Links to a Subscriber's owner or member parts are Associations leading to those other Subscribers; membership is a special case of Association.

Predefined attribute-value pairs are the Subscriber fields of FIG. 1. Some of the field base types are class names defined below. The following discussion provides descriptions of the roles of these fields in Subscriber and its subclasses.

ID is the unique database identifier (DBID) for the object.

The deviceToLocations field maps one or more device IDs to a Subscriber's location history. A device ID is a unique identifier for a terminal device such as a handset in physical space or a computer in URL space. The Subscriber ID combined with a device ID form a composite key that tracks the movement of a Subscriber in a locational space. The location history for a single device ID is a first-in, first-out (FIFO), chronological sequence of LocationAPI objects in a single locational space such as Geographic, Health, URL, or Alarm Space. Proximity of two Subscribers within a device ID's locational space is determined by comparing their current Locations in that space. Determining relative movement of two Subscribers requires a location FIFO of depth 2 for at least one Subscriber's device ID. Finally, for each Subscriber, there is one device ID whose Location objects are capable of locating the nearest LocationServer of FIG. 1. Typically this is a device ID associated with Geographic Space. It locates the mobile user in the world, and it locates the inference server nearest to the user.

LocationAPI objects within deviceToLocations locate the Subscriber object's device. Locations are usually nested hierarchical areas, e.g., “U.S.”→“Nevada”→“Las Vegas”→physical locator such as GPS coordinates or LAN (local area network) identifier. A set of physical locators such as GPS coordinates may also define a bounding area or bounding volume for a Subscriber. LocationAPI also records the time its location was entered and possibly exited. Persistent, stable Locations contain their own unique DBIDs and reside in the Object-Oriented Database (OODB) as first class objects. The Location of a city or of a particular stationary Establishment are examples of persistent, DBID-identified Locations. A transitory Location for a mobile Subscriber, on the other hand, does not have a DBID and associated first-class existence. It exists only within the deviceToLocations field of its Subscriber object. If a mobile Subscriber moves into the enclosing area of a DBID-bearing Location, the Subscriber's new transitory Location in that space records the DBID of its surrounding “parent Location.”

The Associations field is the list of explicitly stored Association DBIDs for this Subscriber, each of which contains the fields shown in the Association class, discussed in detail below. The Subscriber maintains this list in descending order by Association strength, so that inference can inspect stronger Associations before weaker ones.

The preferences field is the list of explicitly stored Preference DBIDs for this Subscriber. The Subscriber maintains this list in descending order by Preference strength, so that inference can inspect stronger Preference before weaker ones. Each Preference is a logical rule for defining implicit Associations by querying the keyword indices stored within a nearby LocationServer. A LocationServer maintains query indices for the keywords for all Subscribers within its extents. In addition to a keyword query formula, a Preference houses strength, blocking flags and other Association fields for implicit Associations to its keyword-located target Subscribers. If a mobile Subscriber reinforces a particular implicit Association created from a Preference in a locale, that Association becomes an explicit member of the Associations field.

Each threshold is a limit on outgoing Activation strength, 0.0<=threshold<=1.0 in this exemplary implementation of the current invention, for each Association or Preference labeled with that threshold text tag. If an outgoing Activation falls below this level or to 0.0 after crossing Associations, its propagation stops.

A Contact is a means for a Subscriber to contact another Subscriber, such as a telephone number or an electronic mail address.

The Keywords field contains extensible keyword tags for the Subscriber object. Query formula in Preferences query a LocationServer's database of keyword-to-Subscriber DBID mappings to locate target Subscribers.

The incomingblocks and outgoingblocks fields determine when to block delivery of information to the initiating Subscriber owning the incoming blocks, and when to block notification of target Subscribers identified by the outgoing blocks. Both incomingblocks and outgoingblocks can hold a list of Subscriber DBIDs to be blocked, as well as keywords for blocked Subscribers, essentially blocking classes of Subscribers tagged with those keywords. The logic of these blocks can be inverted by respective boolean flags. When inverted, a DBID list identifies Subscribers who are allowed to interact with the allowing Subscriber. An inverted, allow list is more selective than a block list, because a block list allows every Subscriber to interact except the explicitly blocked Subscribers, while an allow list allows only the explicitly identified Subscribers to interact.

A previous paragraph on Subscriber ownership and membership discusses fields ownerDBID, ownedDBIDs, superorgDBIDs and suborgDBIDs.

Status shows whether the Subscriber is available to interact with associated Subscribers. Exemplary status values could include StatusUnknown, StatusAvailable, StatusAway, StatusBusy, StatusAlarm and StatusCancelAlarm.

Schedule is a class that defines one-time or recurring status events as a function of time. Each Subscriber houses one Schedule object, which consists of zero or more ScheduledEvent objects. Each ScheduledEvent object is either a one-time or a recurring calendar function with a start date-time, a life span or an occurrence count, and parameters that determine when the ScheduledEvent applies, its duration, and any advance warning time. Each ScheduledEvent can generate a Timeline for a concrete period of time, showing when that ScheduledEvent applies to that period of time. A ScheduledEvent also has a status from the list of the previous paragraph. That list appears in ascending order by priority. A Schedule generates a Timeline for its collection of ScheduledEvents by generating their respective Timelines, and then using status priority to resolve timing conflicts. The highest priority gets the time slot. Scheduling of Schedule-driven Subscriber status changes, and generation of AlarmLocation movement when a Subscriber's status enters the StatusAlarm state, are performed by a server process.

The locationservers field lists DBIDs of LocationServer objects in one or more locational spaces in which the subscriber object currently resides.

There are additional fields housing learning-related parameters and data for learning and discarding Associations and Preferences and for adjusting their strengths, based on statistical analyses of Subscriber interaction patterns.

FIG. 1 shows that a given Subscriber can contain zero or more Associations with other Subscribers, and that each Association belongs to exactly one Subscriber. An Association is both directional and asymmetric. Subscriber A may define an Association to Subscriber B, and Subscriber B may define an Association with different properties to Subscriber A, or perhaps no Association to A at all. An Association is a Subscriber's private data, made available to other Subscribers only as part of the inference engine's activity, and then only if the Association's permit field allows Activation by other Subscribers. Transitive Activation across more than one Association amounts to borrowing another Subscriber's Associations for inference.

FIG. 1 also shows that a Subscriber can contain zero or more Preferences, with each Preference belonging to exactly one Subscriber. FIG. 1 further shows that Associations and Preferences share exactly the same fields, their primary difference being the semantics of the to field. The other main difference is that inference crosses multiple Associations in transitive paths, while the current exemplary design of inference uses only the originating Subscriber's Preferences in a non-transitive manner. Preferences are not intrinsically non-transitive; this restriction is in the exemplary implementation of the inference algorithm to avoid exponential growth in search time of the Activation space.

The following discussion provides brief descriptions of the fields in Association and Preference. Each has a unique database ID (a.k.a. DBID) in the object diagram, used to store a reference to the Association or Preference within its Subscriber. Each gives its owner Subscriber's DBID in the from field.

An Association gives its target Subscriber DBID in the to field. A Preference gives its keyword query formula in the to field. This formula may be a simple keyword to be matched precisely, a keyword with a trailing for so-called ‘glob’ prefix matching, or an expression consisting of keyword subexpressions joined by ‘and,’ ‘or,’ ‘minus’ and ‘not’ for finding intersection, union, set difference and inversion of the results of subqueries. These queries apply to keyword indices in the mobile Subscriber's LocationServer.

Label is a text string such as “friend” used as a key in looking up a Subscriber's Activation threshold for this Association or Preference. See the discussion of Subscriber thresholds in the previous section.

Strength is a multiplier between 0.0 and 1.0 for inference. A different numerically weighted exemplary implementation of the present invention might use a different number range.

Proximity in physical distance helps to determine when the target Subscriber of this Association or Preference becomes a candidate for Activation. The abstract Location interface LocationAPI defines abstract values LocationUnknown, PositionIdentical, PositionInside, PositionSurrounds, PositionOverlapping, PositionAdjacent, PositionNear and PositionFar. PositionIdentical through PositionFar are in descending order by proximity. Concrete LocationAPI-derived classes provide algorithms for determining proximity relations of two Location objects, and Subscriber-specific parameters set limits such as the near-far boundary for a given Location object or pair of objects being compared. Relative proximity of two Locations is somewhat less important than relative movement of one Subscriber with respect to another, which is the subject of the next field. Movement detection uses proximity comparison algorithms and values.

A Movement relation between two Subscriber's current Locations in a concrete Location Space also helps to determine when the target Subscriber of this Association or Preference becomes a candidate for Activation. The abstract Location interface LocationAPI defines abstract values LocationUnknown, MovementInto, MovementAround, MovementInContact, MovementNear, MovementNone, MovementOutof, MovementEjected, MovementTowards and MovementAway. MovementInto through MovementAway are in descending order by dynamic proximity. Concrete LocationAPI-derived classes provide algorithms for determining movement relations of two Subscriber's FIFO history of Location objects. Relative movement is the primary means for selecting new target Subscribers reached via Associations and Preferences.

Proximity and movement are not considered as part of transitive Association crossing. Otherwise, transitive Associations across non-local Subscribers could not occur. Proximity and movement tests help determine target Subscribers in the originating Subscriber's locale, i.e., at the end points of transitive inference.

An incomingblock determines whether to block information arriving at the blocking Subscriber via an Association in two ways. It blocks the collection of data about blocked target Subscribers during the initiating Subscriber's inference, manifest as the return value for the initiating Subscriber's movement operation. Blocked Subscribers are missing from the returned results. An incomingblock also blocks notification of a target Subscriber when inference is initiated by a blocked originating Subscriber. Both uses of this block avoid receiving information about unwanted Subscribers, reducing contact overload.

An incomingblock may take on values of BlockNone, BlockTransitiveAnd or BlockTransitiveOr. BlockNone is no block. BlockTransitiveAnd blocks information from a Subscriber reached via multiple Associations starting with the Association in question, if and only if all Activations reaching that Subscriber are blocked in some way, i.e., not BlockNone. BlockTransitiveOr blocks information from a Subscriber reached via multiple Associations starting with the Association in question, if any of the Activations reaching that Subscriber are blocked in some way.

The transitive blocks seem complicated for users if considered from an abstract perspective, but it is possible to give examples to a Subscriber who is setting up or updating Associations and Preferences. For example, if Subscriber A blocks incoming information from Subscriber B, the configuration user interface can ask, “Do you want to block incoming information from i) all associates of Subscriber B whom you can find only through Subscriber B, or ii) all associates of Subscriber B?” These choices correspond to BlockTransitiveAnd and BlockTransitiveOr blocks respectively. A Subscriber can also set a default parameter for Association and Preference creation.

An outgoingblock when non-empty blocks information arriving at a nearby associated Subscriber. That Subscriber is not made aware of the mobile Subscriber's movements and inferences in the system. Block types again may take on values of BlockNone, BlockTransitiveAnd or BlockTransitiveOr. BlockNone is no block, BlockTransitiveAnd blocks notification if all Activations arriving there propagate an outgoing block, and BlockTransitiveOr blocks notification if any Activation arriving there propagates an outgoing block. Once again, examples and defaults can ease the difficulty of setting user Preferences.

Permit determines which Subscribers other than the owning Subscriber may use an Association or Preference. Permit can take on values of PermitNone, PermitAny, or an explicit list of DBIDs for Subscribers.

The boolean isTransitive field determines whether inference stops its forward search at the target of this Association or Preference. Activation may still proceed across other paths that do not use a specific non-transitive link. An Association or Preference should be made non-transitive when its target Subscriber should not relay information about the originating Subscriber's movement further in the inference network. Emergency Health, Temporal Alarm, and stolen Property movements are three type of events that might be directed only to specific caretakers or owners via Associations, or to a class of service providers via Preferences, that have the permit field set to PermitNone and isTransitive set to false.

The locationClassUniverse field determines the Location Spaces to which this Association or Preference applies, such as Geographic Space, URL Space, Health Space, Alarm Space, etc. If this field is empty, then all Location Spaces apply. This field inhibits inappropriate cross-coupling between Location Spaces, for example notifying a care giver when a patient with Health Space monitoring moves within an unrestricted Geographic Space. Note that if Geographic Space becomes important to this monitored patient, e.g., MovementOutof a hospital or nursing home facility, that monitoring could be added via additional Associations or Preferences.

Another possible filter field would limit application of a Preference in finding target Subscribers to specific subclasses of Subscriber, i.e., one or more of Person, Property or Establishment. This filter is not necessary for Association, since an Association object leads to only one target Subscriber of a concrete class. This filter may be useful for Preferences, however.

The exemplary implementation of the present invention defines intuitive categories for Association and Preference strength and inference activation level numbers, such as the following:
1.0 is an absolute (very strong) Association or Preference or Activation Level
0.66<=n<1.0 is a strong Association or Preference or Activation Level
0.33<=n<0.66 is a medium Association or Preference or Activation Level
0.0<n<0.33 is a weak Association or Preference or Activation Level
0.0 is a missing (no strength) Association or Preference or Activation Level
   Finer gradation is possible or the use of statistical distributions such as Gaussian may provide more accurate strength classification. Such intuitive categories are easier for Subscribers to use in setting up thresholds, Associations and Preferences than requiring them to use numeric values.

Class ContainerPreference of FIG. 1 is a subclass of Preference. As a subclass of Preference, ContainerPreference may be used, in certain circumstances as a substitute for Preference. For example, when a subscriber subscribes to a particular service provided by a service provider, the service provider may establish a base line of Preference as a Container Preference. In other words, the service provider may “fill” the ContainerPreference with basic information about the provider and, optionally, basic information about the subscriber. The ContainerPreference may include simply information concerning the identity of the service provider and the geographic region in which the provider provides service, for example. The information included in the ContainerPreference, therefore, may not be provided by the user. Instead, the information included in the ContainerPreference may be selected by the service provider. For this reason, the information provided by the provider is referred to as provider-selected information.

The information included in the ContainerPreference information is intended to cooperate with the information in the Preference for purposes of the invention. For example, the user may select specific information, called user-selected information, that may be stored in the Preference or in the ContainerPreferrence depending upon the operational parameters of the system. In the basic example, the user-selected information will be stored in the Preference, while the provider-selected information will be stored in the ContainerPreference.

ContainerPreference differs from Preference in that ContainerPreference does not match keywords to Subscriber IDs via a LocationServer. Instead, it inspects the LocationAPI object representing its Subscriber's location after the Subscriber moves in a location space. A ContainerPreference generates a Temporary Association to a Subscriber occupying the locational container of the mobile Subscriber's location if there is one. For example, if a mobile Subscriber walks into a subscribing hardware store, the mobile Subscriber's ContainerPreference generates a Temporary Association to the hardware store Establishment. In addition to linking to a containing Subscriber, ContainerPreference also generates a Temporary Association to each contained Subscriber. Locationally contained Subscriber linkage makes use of the fact that, unlike base class Preference, inference across a series of ContainerPreference objects is normally transitive. The Subscriber walking into a hardware store generates not only a Temporary Association to the store, but also a somewhat weaker, transitive Temporary Association to each occupant of the store.

The working of ContainerPreference implies that, in addition to keyword indices, the present invention maintains nested locational search indices that are housed in or otherwise associated with LocationAPI objects. The upcoming discussion of LocationAPI and its subclasses explores some of the details.

One goal in the design of ContainerPreference is to allow learning to operate with a minimum of explicitly user-entered Associations and Preferences. As the foregoing makes apparent, the minimum of user-selected information may be zero. In other words, the user may not place any information into the ContainerPreference. Instead, as noted above, this information may be entirely provider-selected. With a ContainerPreference attached to every Subscriber, mobile Subscribers can learn initial Associations to other Subscribers by traveling and interacting with People and Establishments. After a Subscriber acquires a repertoire of Associations via interaction, the Subscriber can generalize these Associations into Preferences if the Associations have sufficiently strong correlation to Subscribers with common keywords. These learned Preferences and the original ContainerPreferences now generate new Temporary Associations that, when used, create persistent Associations. Creating Associations from Preferences is a form of specialization. The key to the generalization process is the rich and consistent use of keyword tags by Subscribers who wish to be generalized into Preferences. The key to the specialization process is selection of target Subscribers for interaction by a mobile Subscriber.

One potential problem with a ContainerPreference is the fact that, if it is used consistently by its Subscriber, it strength tends to grow close to the asymptote of 1.0. As it does so, transitive ContainerPreference strengths computed by multiplying ContainerPreference strengths also approach 1.0. At this point shared containment could come to dominate all other Associations and Preferences in inference.

The solution to this problem in the current exemplary implementation is to configure ContainerPreference strength to saturate at some reasonably high value. The current default, which can be overridden for any ContainerPreference object, is a strength of 0.75. A single transitive step gives a strength of 0.5625 (0.75×0.75), and so on. This approach appears to work as well or better than more complex alternatives. ContainerPreference also has a lower bound on strength that defaults to 0.25 unless overridden. The upper limit avoids allowing ContainerPreference to dominate Activation, and the lower limit avoids allowing a Subscriber who does not normally reinforce ContainerPreference from becoming completely blind to the surrounding environment.

The remainder of this section consolidates design information about abstract class LocationAPI and its concrete subclasses that has already appeared in previous discussion.

Geographic location data is available in a wide variety of computer-accessible formats. Street address/intersection/zipcode style data is one familiar example. Latitude/longitude style data associated with GPS is another. There are many code libraries, frameworks and databases available on the World Wide Web and within embedded devices such as GPS units for converting between various location formats and for providing value-added features such as route planning, route guiding, travel-time estimation and time-of-day congestion avoidance. Available services and data grow in volume and sophistication each year. As a result, much of the geographic data manipulation capability required by the present invention will be provided by external software and data providers. Those data and services are not part of the present invention.

In addition to Geographic Spaces, some locations within this mobile Subscriber architecture could be other types of non-physical, virtual locations, such as locations in URL Space, Health Space, and Temporal Alarm Space. There are an assortment of ways to implement location descriptions (e.g., coordinates, street addresses, URLs, health metrics, timestamps) within such Locations. There may be additional Location classes that turn out to be useful as well.

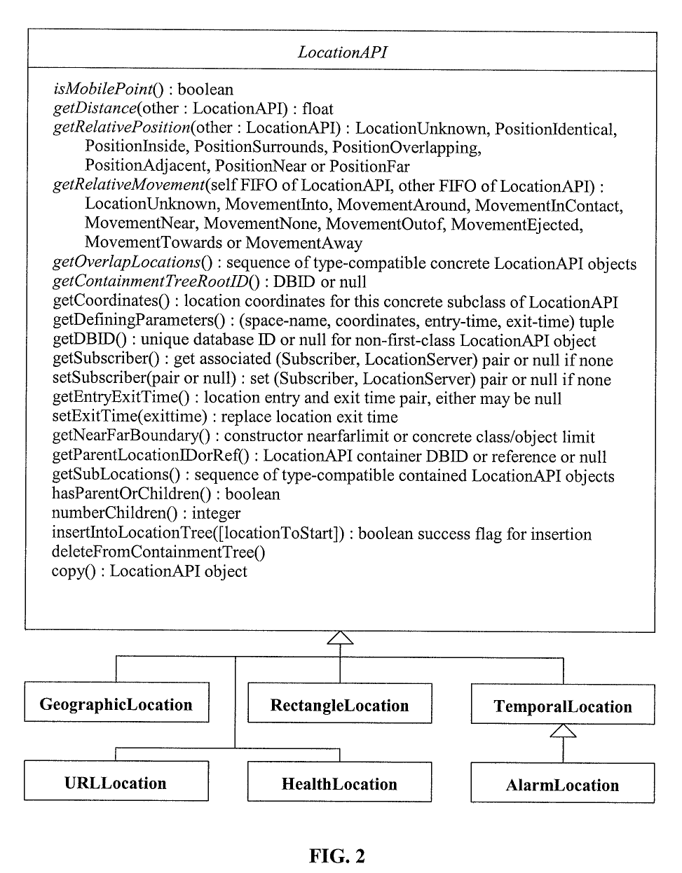

Fortunately, the inference engine does not encode any dependency on location representation detail; instead it uses the abstract LocationAPI class of FIG. 2.

LocationAPI is not strictly an interface, but rather an abstract class. It declares a number of abstract interface operations that are defined by concrete derived classes, represented by operations shown in italics in FIG. 2, as well functions and fields shown in regular type in FIG. 2.

Abstract operations are conceptual properties within and relations between concrete LocationAPI-derived objects. The following discussion summarizes these operations in connection with FIG. 2.

Operation isMobilePoint( ) returns true if its object is a singularity capable of movement and incapable of containing other LocationAPI objects, otherwise returning false.

Operation getDistance( ) returns a floating point distance to another object of the same concrete class. The class determines measurement and interpretation of the value. This is mostly a helper operation for other LocationAPI operations.

Operation getRelativePosition( ) returns one of the symbolic relative position indicators between two concrete LocationAPI objects shown in FIG. 2. These values are the basis for proximity tests in inference.

Operation getRelativeMovement( ) returns one of the symbolic relative movement indicators between two FIFO sequences of concrete LocationAPI objects shown in FIG. 2. These values are the basis for movement tests in inference. (MovementEjected is the inverse of MovementOutof. If Subscriber A moves out of location B relative to A's earlier location, then B has ejected A.)

Operation getOverlapLocations( ) returns a set of LocationAPI objects that overlap the invoking object in its Location Space. This set is empty for a mobile point.

Operation getContainmentTreeRootID( ) returns the root LocationAPI object of the concrete class for the invoking object, if that concrete class has a unique root, otherwise returning null. This operation is predicated on the fact that some Location Spaces are global and include a global, outermost container that contains all other instances of LocationAPI objects in that class. Operation getContainmentTreeRootID( ) provides a means for retrieving that class-specific containment root, when it exists. Some classes implement only locally defined containment hierarchies. For example, a Health Space might be shared only between a circumscribed set of patients and health care providers, not making use of a global root. Geographic Space, in contrast, is usually a public Space with a global outermost container.

Each concrete class derived from LocationAPI implements the above abstract operations. Concrete classes also interpret the coordinate string and nearfarlimit parameters passed to their constructors and stored in the LocationAPI base class portion of their objects.

The two primary concrete functions supported by base class LocationAPI are optional first-class persistence and locational containment. First-class persistence is accomplished by giving a LocationAPI object a non-null DBID. Upon construction and mutation such DBID-bearing LocationAPI objects store themselves in the same object database that houses Subscribers, Associations and Preferences. Typically, all LocationAPI objects with an isMobilePoint( ) value of false will have a DBID. These range from a global object returned from getContainmentTreeRootID( ) down to stable, persistent locational extents for Establishments. Any LocationAPI object that is stable, persistent, and that is to be permanently linked into the containment indexing scheme discussed next must have a DBID.

Non-DBID-bearing LocationAPI objects are typically the transient mobile locations of mobile Subscribers. These second-class locations achieve persistence only when housed within persistent, DBID-bearing Subscribers or other persistent objects. There are many of these short-lived objects, and their primary use is representing location histories of mobile Subscribers.

Subscriber location histories may contain a mix of DBID-bearing and non-DBID-bearing LocationAPI objects. Stable Establishments often contain only a single DBID-bearing concrete LocationAPI-derived object.

The locational containment aspect of LocationAPI objects consists of parent and children fields and most of the concrete LocationAPI functions of FIG. 2 for manipulating containment trees. Class LocationAPI's main concrete task is the provision and maintenance of concrete containment trees that provide a means for searching Geographic and other Location Spaces by proximity and containment. The parent-children links within LocationAPI objects represent hierarchical locational database search indices, in addition to the keyword search indices organized at LocationServers already discussed. Just as a Preference searches keyword indices at a nearby LocationServer, a ContainerPreference searches parent-children links within a hierarchy of LocationAPI objects that enclose and abut a mobile Subscriber's current LocationAPI object and location history.

Parent and children links take the form of DBID strings for DBID-bearing LocationAPI objects, and direct references to non-DBID-bearing LocationAPI objects. Class LocationAPI allows the subtrees of non-DBID-bearing objects, if any, to contain only non-DBID-bearing objects. The persistent roots and supertrees of Location Spaces consist of DBID-bearing LocationAPI objects. Typically only the leaves of containment tree are non-DBID-bearing, isMobilePoint( ) LocationAPI objects that house the transient locational state of mobile Subscribers.

The following discussion summarizes the concrete operations of class LocationAPI of FIG. 2.

Function getCoordinates( ) returns the coordinate string parameter passed to the constructor. This string parameter gives the coordinates of the LocationAPI object in its concrete class Location Space. This is the value that a mobile device sends to the MyLocationInfo server, in the form of a string to be interpreted by its concrete class constructor. Base class LocationAPI does not interpret this string.

Function getDefiningParameters( ) returns the concrete locational class name, the coordinate string, the entry time and the exit time parameters passed to the constructor. This is sufficient information to fully construct a concrete LocationAPI-derived object. A mobile device passes these four fields to a LocationServer every time a Subscriber device moves a significant distance, or at regular temporal intervals.

Function getDBID( ) returns the DBID for a DBID-bearing object, otherwise returning null.

Function getSubscriber( ) returns a reference to an application object passed to the constructor as its application object parameter or passed to setSubscriber( ) to update this LocationAPI field. A Subscriber object uses these functions to configure LocationAPI objects in its location history to link to application 2-tuples consisting of (subDBED, locsrvrDBID), where subDBID is the DBID of the Subscriber object occupying that location, and locsrvrsbid is the DBID of the closest LocationServer object, found by walking up the containment tree and invoking getSubscriber( ) until a 2-tuple housing a LocationServer DBID is found. A LocationServer is a stationary Subscriber with a DBID-bearing LocationAPI location linked into a stable, persistent containment tree.

Function getEntryExitTime( ) gets the entry and exit times for a location, and setExitTime( ) updates the exit time, typically when a mobile Subscriber leaves a prior location and constructs a new one.

Function getNearFarBoundary( ) returns the nearfarlimit parameter optionally passed to the constructor, and interpreted and set by the concrete class constructor. This value determines the boundary between getRelativePosition( ) values of PositionNear and PositionFar, and can be customized at a per-LocationAPI-object granularity. Typically, an Establishment interested in attracting customers will use a larger value than mobile Subscribers; getRelativePosition( ) uses the larger of the two nearfarlimits when comparing two LocationAPI objects. A mobile Subscriber can customize this limit via the mobile client terminal that sends movement information to the nearest LocationServer. If a user is getting too many prospective contacts from faraway Subscribers, for example, the user can lower this value.

Operation getparentLocationIDorRef( ) returns a DBID string for a DBID-bearing parent container, a LocationAPI object reference for a non-DBID-bearing parent, or null for an object with no containment parent.

Operation getSubLocations( ) returns a sequence of DBIDs and/or object references for contained LocationAPI objects. Parameters to this operation select from among one or more of the four types of children potentially available—DBID-bearing-non-mobile, non-DBID-bearing-non-mobile, DBID-bearing-mobile, and non-DBID-bearing-mobile—and whether to fetch DBIDs from the database and return their object references.

Operation hasParentOrChildren( ) returns true if its object is linked into a containment tree, i.e., it has a parent or at least one child, otherwise returning false.

Operation numberChildren( ) returns the number of contained children. Like getSubLocations( ) it can select from the four types of children in determining the number.

Operation insertIntoLocationTree( ) is the linchpin of LocationAPIs locational indexing. It locates the smallest LocationAPI object in a containment tree for which getRelativePosition( ) yields PositionInside, then inserts the invoking LocationAPI object into that surrounding object's children linkage sequence. It will not insert a DBID-bearing object under a non-DBID-bearing object, moving up the tree as needed. The optional locationToStart parameter provides a potential container in which to start looking. Insertion search proceeds upward until a surrounding LocationAPI object is found, and then down. If locationToStart is null and getContainmentTreeRootID( ) is non-null for that concrete class, then the global root is used as locationToStart. Construction of isolated trees not connected to a global root can always be forced by constructing a non-global root LocationAPI object and always using it as the locationToStart parameter. Insertion returns true if successful, and false if insertion failed due to lack of a container in which to insert this object.

Operation deleteFromContainmentTree( ) removes this object from its containment tree (if any), moving its children (if any) up one level in the containment tree if it has a parent.

Operation copy( ) constructs a new object of this object's concrete class, with the same coordinate, time and nearfarlimit fields, but with no DBID or parent/child linkages. It is useful for passing strictly locational information via transient objects.

The concrete derived classes below LocationAPI in FIG. 2 implement Location Spaces as already discussed. The 2D RectangleLocation class, along with HealthLocation, TemporalLocation and its AlarmLocation subclass have been implemented as part of a prototype. Class GeographicLocation has been designed and implemented to use coordinates that are compatible with industry standard geographical location data formats such the GPS NMEA data protocol, the GPX format for recording GPS coordinate paths, the GML and CityGML geographic information data repository formats, and the GeoRSS location data streaming format. Much of the work in supporting GeographicLocation and URLLocation consists of designing and writing adapters to fit them into the substantial code libraries and databases for geographic and URL-based systems that already exist, as should be appreciated by those skilled in the art.

### II. Automatic Search and Subscriber Activation

The goal of inference is one of efficiently finding the intersection of the two sets {ThingsThatExciteAMobileUser} ∩ {ThingsThatHaveBecomeNearAMobileSubscriber} and presenting them to Subscribers via a small, portable device. ThingsThatExciteAMobileUser take the form of Subscribers that are the targets of high strength Associations and Preferences. This may be a large set. ThingsThatHaveBecomeNearAMobileSubscriber may also be a large set, especially in a populous city. Inference cannot eagerly construct these two large sets and then compute their intersection with any hope of efficiency.

The design of inference for the present invention uses the following mechanisms to minimize search overhead.

The primary mechanism is the strategy of lazy evaluation. This strategy applied to inference in the present invention says never to generate a Temporary Association from a Preference nor follow an Association or Temporary Association to activate a target Subscriber until necessary.

Activating a target Subscriber only becomes necessary when a mobile Subscriber requests seeing an additional target Subscriber brought into proximity by the mobile Subscriber's latest movement. A Subscriber cannot view many choices at one time on a mobile device, and a mobile device cannot store an unlimited number of potential choices. These design constraints at a mobile device makes lazy evaluation permissible, but they do not suggest how to achieve it.

They key to achieving lazy evaluation is the realization that at each step of inference, the highest priority uninspected Subscriber is always known, and the highest priority uninspected Subscriber is always the next one to inspect. If a mobile Subscriber's device requests information on ten additional target Subscribers, it is necessary for inference to visit ten additional target Subscribers. The algorithm outline below shows how to visit only required Subscribers in a lazy, incremental manner.

Lazy evaluation is not the only way to implement the present invention. Eager evaluation would search exhaustively for all candidate Subscribers in a locale with Activation strengths lying above a threshold value. Lazy evaluation is more efficient when searching among a large set of candidate Subscribers when only a portion of them will be considered for communication. Eager evaluation is more efficient than lazy evaluation in the case where search presents all candidate Subscribers to the originating mobile Subscriber, since lazy evaluation requires additional steps beyond eager evaluation to limit the search.

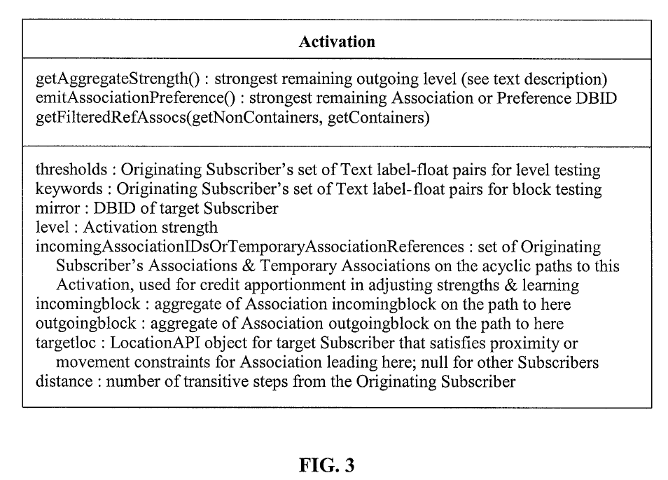

FIG. 3 shows the class diagram for Activation.

A mobile Subscriber's collection of Activation objects stores the state of inference after a device notifies the inference server of a move. Inference works by incrementally creating a set of Activation objects, each of which corresponds to a unique Subscriber object, until the process of Activation dies out due to a termination of requests from the originating Subscriber or due to diminishing Activation level. Different Subscribers can concurrently initiate distinct rounds of Activation inference in a server. These Activation universes do not interact with each other except to the degree that they share Associations and Preferences to determine candidate Subscribers for Activation.

This exemplary implementation of the present invention supports multithreaded Activation, with each initiating Subscriber allocated one thread to work on its universe of Activations.

Operation emitAssociationPreference( ) is an iterator that returns the DBID of the strongest remaining Association or Preference of the Activation's Subscriber that was not previously returned by emitAssociationPreference( ). The strength of the strongest Association or Preference not yet emitted by emitAssociationPreference( ) multiplied by the Activation's level, gives the value returned by operation getAggregateStrength( ).

Operation getFilteredRefAssocs( ) is not part of inference. Learning algorithms invoke this algorithm to sort the originating Subscriber's Associations and Temporary Associations on the path to the Activation's Subscriber, with Associations preceding Temporary Associations, and with Temporary Associations from regular Preferences preceding Temporary Associations from ContainerPreferences.

The following paragraphs define the fields listed in FIG. 3.

The thresholds field is a read-only reference to the originating Subscriber's dictionary of thresholds for Association/Preference labels that is shared by all Activations. An Activation's emitAssociationPreference( ) operation does not return an Association or Preference whose strength lies below its threshold.

The keywords field is a read-only reference to the originating Subscriber's keyword tags. Activation's emitAssociationPreference( ) operation checks keywords against a potential target Subscriber's incoming blocks.

The mirror field is the DBID of the target Subscriber that this Activation inspects.

The level field is the transitive strength of inference at this node in the activation graph as outlined below.

The incomingAssociationIDsOrTemporaryAssociationReferences field is a collection of Associations and Temporary Associations leading out of the originating Subscriber and lying on an inference path to this Activation. Converging paths in a DAG (directed acyclic graph) contribute more than one element to this field, and inference updates this field every time it visits an Activation via a different path. Learning later uses this collection to assign credit to the originating Subscriber's Associations and Preferences that lead to target Subscribers to be considered (the so-called InspectedSet of target Subscribers) and that lead to target Subscribers actually contacted by the originating Subscriber (the so-called SelectedSet).

The incomingblock field stores the combined value of BlockNone, BlockTransitiveAnd and BlockTransitiveOr values obtained from getIncomingBlock( ) calls along paths leading to the Activation. A single BlockTransitiveOr along a path saturates incomingblock at subsequent Activations. Otherwise, the first BlockNone to reach an Activation along some path cancels any preceding BlockTransitiveAnds at that activation.

The outgoingblock field stores the combined value of BlockNone, BlockTransitiveAnd and BlockTransitiveOr values obtained from getOutgoingBlock( ) calls along paths leading to the Activation. Aggregation logic is similar to incomingblock.

The targetloc is a LocationAPI object for the Activation's target Subscriber that satisfies proximity or movement constraints for an Association or Temporary Association leading to this Activation. This field is null for an Activation whose Subscriber is not in the proximity of the originating Subscriber. It is used in reporting back to the originating Subscriber the location of a potential contact after inference.

The distance is the length of the inference path from the originating Subscriber to this Activation.

The following paragraphs outline the Lazy Inference algorithm.

Consider an Activation's DBID-level pair. The DBID is the Subscriber database ID that uniquely identifies a Subscriber. In the exemplary implementation of the present invention, the level of the originating Subscriber is an activation level of 1.0; the level for any other, target Subscriber is the activation level found by multiplying 1.0, the activation level of the originating Subscriber, by the product of the strengths of all Associations and Temporary Associations crossed in the strongest acyclic path reaching a target Subscriber from the originating Subscriber.

As should be appreciated by those skilled in the art, a different implementation of the present invention may use a different interpretation of Association and Preference strength numbers and Subscriber thresholds, and a different mathematical approach for combining them into an activation level.

The Lazy Inference algorithm may be implemented as outlined in the following seven operations.

1. Create an Activation for the originating Subscriber DBID at a level of 1.0.

2. A Subscriber maintains its associations and preferences fields in sorted order by strength. In iterating over the lists of Association and Preference objects, the strongest one is always the next to be inspected via a single inspection step. When there is a tie in strength between the next Association and the next Preference, the Association is treated as stronger. The strongest remaining outgoing level of an Activation, returned by operation getAggregateStrength( ), is the product of its level and the strength of its strongest remaining Association or Preference not yet emitted by emitAssociationPreference( ). An Activation uses a single pass, incremental merge algorithm to iterate over the associations and preferences lists in descending order by strength.

3. Sort all Activations by the strongest remaining outgoing level. By maintaining Activations in a priority queue, initially consisting of the Activation of the originating Subscriber, it is possible to perform this step in O(log(n)) time, where n is the number of Activations that have not emitted all of the contents of the merged associations-preferences lists from their Subscribers.

4. Retrieve the Activation with the strongest remaining outgoing level from the top of the heap, and retrieve the strongest Association or Preference that this Activation has not previously emitted. The strongest Association leads to one target Subscriber, whose Activation level is this Activation's strongest remaining outgoing level. The strongest Preference leads to zero or more target Subscribers, whose Activation levels equal this Activation's strongest remaining outgoing level.

Use the label on this strongest Association or Preference as a key to retrieve a threshold from the originating Subscriber. If the strongest remaining outgoing level is less than the threshold, return to step 3; do not use this Association or Preference. This step of threshold testing, used in the exemplary implementation, is optional in the present invention.

Inference uses an upper limit on the maximum number of steps in an activation path. There is a default value in the exemplary implementation, which can be adjusted for each originating Subscriber. When the number of steps leading to an Activation equals this limit, it is not placed on the priority heap, since all paths leading out of it would exceed the step limit. This step of path length testing, used in the exemplary implementation, is optional in the present invention.

If all converging Associations and Preferences leading to an Activation are not transitive (isTransitive field of Associations and Preferences are false), do not add the Activation to the priority heap.

If there is a locationClassUniverse constraint on the current Association or Preference leading to a Subscriber, and it does not match the class of the originating Subscriber's location of movement, do not use the Association or Preference to create or revisit an Activation. Instead, return to step 3.

If an Activation exhausts its Subscriber's sorted lists of Associations and Preferences, remove it from the priority heap and return to step 3.

5a. For an Association, determine if the target Subscriber has already been activated. If it has, inference has found a converging path or a cycle; it creates no new Activation, although it does add to the incomingAssociationIDsOrTemporaryAssociationReferences field the Association or Temporary Association leading from the initiating Subscriber along this path, for later credit apportionment in adjusting strengths for used and unused inference paths.

If the target Subscriber has not been activated, create an Activation for it with a level equal to the prior Activation's strongest remaining outgoing level, then add the new Activation to the priority heap in O(log(n)) time. Add to the incomingAssociationIDsOrTemporaryAssociationReferences field the Association or Temporary Association leading from the initiating Subscriber along this path for later credit apportionment.

5b. Crossing a Preference entails incremental generation of Temporary Associations to target Subscribers, all at the same level, i.e., the strongest remaining outgoing level. The Preference being crossed performs this task. When a Preference has the strongest remaining outgoing level, it generates only as many Temporary Associations as are requested. Like the incremental iterator for an Activation's emission of Associations and Preferences in descending order by strength, it is a lazy iterator.

A Preference may optionally be tagged with a Subscriber subclass constraint such as Establishment, Person or Property as discussed for FIG. 1. When this constraint is present, the Preference generates Temporary Associations only for Subscribers of the constrained subclass. Such subclass constraints are not needed for Associations, because a given Association object links to exactly one Subscriber object of a given concrete class.

The processing of each Temporary Association emitted by a Preference is the same as step 5a for an Association.

6. As an Activation is created or revisited in step 5, determine whether its Subscriber is a member of the ReturnedSet of Subscribers whose DBIDs will return to the originating Subscriber, or to the ConsumedSet of Subscribers who will receive an invocation of consume( ) for the originating Subscriber.

If the Activation's Subscriber is not in either of theses sets, determine the proximity and the relative movement of the originating Subscriber to the Activation's Subscriber, using the FIFO location history of the two Subscribers. If their relative proximity and movement matches the proximity and movement constraints of the current Association or Temporary Association leading to the Activation, then there is a location match between the originating Subscriber and the Activation's Subscriber.

If there is a location match, and the Activation's Subscriber is not in the ConsumedSet, and there are no outgoing blocks identifying the Activation's Subscriber from the initiating Subscriber or along the inference path to the Activation, and there are no incoming blocks identifying the initiating Subscriber from the Activation's Subscriber, notify the Activation's Subscriber with parameters giving ID and contact information for the originating Subscriber, and add the Activation to the ConsumedSet.

If there is a location match, and the Activation's Subscriber is not in the ReturnedSet, and there are no incoming blocks identifying the Activation's Subscriber from the initiating Subscriber or along the inference path to the Activation, and there are no outgoing blocks identifying the initiating Subscriber from the Activation's Subscriber, add the Activation to the ReturnedSet, and return the Activation's Subscriber's DBID to the originating Subscriber's mobile terminal device as an incremental result.

7. The above incremental steps return at most one target Subscriber DBID per invocation. Subsequent invocations restart the algorithm at step 3 (sorting the top of the heap only when necessary) or at step 5b when incrementally generating Temporary Associations from Preferences. An eager algorithm, in contrast, would return all qualifying target Subscriber DBIDs in one invocation.

### III. Statistical Learning

Learning in the present invention's inference network of Associations and Preferences may optionally occur some time after a mobile, originating Subscriber has moved into a new location and made contact with zero or more of the potential target Subscribers made visible by inference. Contact may be initiated by either the originating or target Subscribers, and both may learn as the result of the interaction. A given Subscriber's learning affects only that Subscriber's Associations and Preferences.

Learning in the present invention includes at least the following five activities.

Strength adjustment increases or decreases the strength of existing Associations and Preferences, based primarily on some function of the ratio of NumberOfTimesSelected to NumberOfTimesInspected. An Association's or Preference's NumberOfTimesInspected is the number of times it was crossed by inference in leading to potential contacts that were actually presented to the learning Subscriber, and its NumberOfTimesSelected is the number of times that potential contacts so inspected were actually contacted by the learning Subscriber for a each Association and Preference.

Garbage collection, the deletion of an Association or Preference, occurs as its strength falls below the threshold associated with its label. Garbage collection can also occur for an Association if its target Subscriber disappears from the database.

Specialization occurs when a Subscriber makes contact with the target of a Temporary Association generated from a Preference or a transitive Association. In this case, if there is no existing persistent Association to the target, learning creates an Association and also strengthens any contributing Preferences.

Generalization occurs when statistical analysis determines that a significant number of strong Associations lead to target Subscribers with a small, consistent set of keyword tags. The strong Associations are correlated with the keywords. In this case it is possible to generate Preferences for those keywords. Generalization need not happen immediately after a move. In fact, it tends to be expensive in computation, network activity and database lookups, and should normally be initiated as a background process during lulls in inference activity.

Credit apportionment determines which Associations and Preferences get credit for what ratio of contacts. The incomingAssociationIDsOrTemporaryAssociationReferences field of an Activation object discussed for FIG. 3 is the key to post-move credit apportionment. It collects the Associations and Temporary Associations (and therefore Preferences) leading from the originating Subscriber onto the path leading to its Activation object. The mirror DBIDs for all Activations inspected by a mobile Subscriber go into an InspectedSet, and the DBIDs for all contacts actually made go into a SelectedSet. The mobile terminal reports these sets back to the inference server. The learning algorithm uses these sets to retrieve Activations, inspect incomingAssociationIDsOrTemporaryAssociationReferences fields and apportion credit.

A target Subscriber makes contacts and learns without relying on any preceding round of its own inference. Calls coming into a target Subscriber from mobile originating Subscribers are so-called cold calls. In the case of these calls, all incoming calls contribute DBIDs to a target's InspectedSet, and the contacts actually made contribute DBIDs to the target's SelectedSet. Credit apportionment simplifies to adjusting strengths on existing Associations leading from a cold call target to Subscribers in both sets, and learning new Associations to Subscribers in the SelectedSet when there are no existing Associations to them. Credit apportionment for inference-invoking originating Subscribers is richer because it works not only with direct originator-to-target Associations and Preferences, but also with its Associations and Preferences leading into transitive paths. One potential enhancement to the learning architecture would be reverse-inference path exploration from target Subscribers to originating Subscribers in the interest of additional credit apportionment for target Subscribers' Associations and Preferences.

The strength of an Association or Preference is an indication of how important it is to the owning Subscriber. The following discusses some of the factors to consider in designing a learning algorithm.

Strength should be a measure of how important a link is when it is activated in a locale. An Association or Preference that is not used because it does not apply in the current locale should not be penalized by having its strength reduced if it is not used in this locale. On the other hand, any Association or Preference that applies in the current locale is a candidate for selection. Therefore, Associations with Activation levels>0 that are visible to a user are candidates for selection. They should be rewarded with increasing strength when used, and penalized with decreasing strength when passed over for another activated Association.

If there are many activated Associations available in a locale, then even the most popular ones may be used relatively few times. For example, if there are 100 restaurants available in a locale, and a mobile Subscriber always chooses the same five with about the same frequency, then even though the Subscriber uses any one of the five “only” 20% of the available time, that 20% should yield a much higher Association strength than 0.20, given the fact that 95% of the available restaurants never receive any activation.

Strength should be a measure of how frequently a link is actually used in its locale, when compared with the overall number of Subscriber selections made in that locale. For example, if a traveler chooses a restaurant in Tokyo only one time a year, but makes only ten total selections in Tokyo for the few days that she is there every year, that one selection should count more than selecting one restaurant once a year in New York City, where perhaps she makes a hundred selections every year. Finding the ratio of NumberOfTimesSelected to NumberOfTimesInspected is the key first step in the present invention's learning mechanisms.

Automatic tuning of Association strengths occurs only for Associations made directly out of the originating Subscriber object. When transitive Association results in a selection of a new target Subscriber, a new Association comes into place directly to that target Subscriber from the originating Subscriber, and its strength is initialized.

### Centile Ranking

One exemplary implementation of the present invention uses an algorithm based on Centile Ranking to rank and adjust strengths on existing and new Associations. It also uses Centile Ranking to rank target keywords for generalization of new Preferences. The design of learning in the present invention does not require these two algorithms to be the same, nor do they have to be the same for two different Subscribers. These two learning algorithms are declared as operations adapt( ) and abstract( ) respectively of abstract interface StrengthLearner. Each Subscriber object can point to a distinct StrengthLearner object of a distinct class if desired; an exemplary implementation of the present invention can load a learner class as a plugin, and adapt( ) and abstract( ) can implement two different learning algorithms. Centile Ranking is one concrete example of a statistical approach to learning, but others are possible with the present invention.

Centile Ranking's main advantage is the fact that it readily deals with skewed distributions. For example, one Subscriber may select a few available restaurants relatively frequently (perhaps 10% to 15% of the time), many others less frequently (1% to 8%), and most available restaurants never at all. A different Subscriber may have a different distribution of restaurant selection. Similarly, the same Subscriber may have a different selection distribution in a different locale, for example depending on frequency of visits to a foreign city and familiarity with the restaurants there. Centile Ranking helps to normalized skewed distributions, concentrating on where an available Association (or keyword for generalization) is ranked with respect to other available Associations (or keywords). This approach normalizes over actual number of Subscriber actions taken in a locale and number of activated Associations available. The remainder of this discussion focuses on ranking Associations, but the same arguments apply to ranking keywords for generalization.

Anyone familiar with standardized tests such as the Scholastic Aptitude Test is familiar with Centile Ranking. A test score at the 60 percentile, for example, is greater than 60% of the test scores. This Centile measure does not reflect the raw test score directly. It reflects ranking of the raw score relative to all other raw scores.

A Subscriber's StrengthLearner plugin maintains Centile Ranking fields in the Subscriber object for all Associations originating at that Subscriber, using the ratio (NumberOfTimesSelected/NumberOfTimesInspected) as a raw score. Table 1 shows a very small Centile Ranking data set for a Subscriber with only five Associations.

The first column gives each Association's raw score of (NumberOfTimesSelected/NumberOfTimesInspected). Note that raw score is strictly a function of Association selection when the Association is actually used in inference. Associations not used in inference are not counted in either SelectedSet or InspectedSet. The learning algorithm converts Subscriber DBIDs in the SelectedSet reported by the mobile terminal to a SelectedSet of originating Subscriber Associations by aggregating all Associations in the incomingAssociationIDsOrTemporaryAssociationReferences fields of Activations keyed on those Subscriber DBIDs. It converts the InspectedSet of Subscriber DBIDs to an Association InspectedSet similarly. If it finds a selected DBID for which it has no directly connected Association, it either generates one from a directly connected Temporary Association (if there is one) or generates one using data from the Activation object otherwise.

TABLE 1
Centile Rankings for 5 Associations

| raw score | | cumulative | | |
|---|---|---|---|---|
| (selected/ | number of | # of | cumulative #/5 | cumulative |
| inspected) | Associations | Associations | Associations | percentile |
| 3/4 = .75 | 1 | 5 | 1.00 | 100^{th} |
| 63/100 = .63 | 1 | 4 | .80 | 80^{th} |
| 21/42 = .50 | 1 | 3 | .60 | 60^{th} |
| 20/80 = .25 | 1 | 2 | .40 | 40^{th} |
| 2/50 = .04 | 1 | 1 | .20 | 20^{th} |

One way this example may be misleading is that often there are multiple novel selections available that the user does not select, giving a large percentage of entries with raw scores of 0.0. These Temporary Associations do not persist because they were never used. They increase the number of available alternative selections, and so they tend to push up the Centile Ranking of Associations actually selected.

Selected Temporary Associations thus contribute to the SelectedSet size, the InspectedSet size, and new persistent Associations. Unused Temporary Associations contribute to the InspectedSet size, i.e., the denominator of column 1 in Table 1. Garbage collection recovers all unused Temporary Associations after learning is completed or upon the next move of the Subscriber device.

Association strength itself derives from the Centile Ranking expressed as a number from 0.0 to 1.0 inclusive, i.e., the fourth column in Table 1. In the absence of user-configured Association strength, the Association in the bottom row of Table 1 would have a strength of 0.20, and the Association in the top row would have a strength of 1.0.

Association strengths configured by a user add hysteresis to adjustment of strength. An exemplary implementation of the present invention uses the following formula in updating an Association strength:

NewStrength=((OldStrength×DragFactor)+Centile Weight)/(DragFactor+1)

DragFactor is a small non-negative integer meant to preserve user strength configuration (and Preference strength), and Centile Weight is strictly the historical Centile Rank that is updated each time that an Association becomes activated and visible to the user. CentileWeight is insensitive to Association strength as configured by a user or Preference; it is strictly a cumulative statistical measure. Note that a DragFactor of 0 leads to using the CentileWeight as the new strength, and that a DragFactor of 1 leads to averaging the old strength and the Centile Rank. A useful exemplary DragFactor value can be determined through experimentation with real data.

In the case where multiple Associations achieve identical raw scores, the Centile Ranking algorithm must group them into equivalence sets by raw score, and then increment cumulative counts and resulting percentiles accordingly. The exemplary implementation performs this equivalence grouping.

Strength adjustment of Preferences using Centile Ranking is essentially identical to Association strength adjustment. Preferences are ranked and strengthened, weakened, or garbage collected according to their Centile ranking in comparison with other Preferences.

Garbage collection removes any Association or Preference whose strength has fallen below its Subscriber's threshold except the ownership and membership Associations used for organizations and property ownership, and ContainerPreferences. These Associations and ContainerPreferences must be removed via explicit deletion requests by their Subscribers.

The present exemplary implementation of Centile Ranking implements generalization by following all of a Subscriber's Associations to target Subscribers and collecting and ranking their keywords, selecting some upper percentile as candidates for generalization into Preferences.

### Bayesian Ranking

The potential for application of Bayesian statistical analysis suggested in this section is inspired by Bayesian statistical filtering of spam email. “Spam” is unwanted electronic mail. Bayesian spam filtering requires a corpus of both spam and non-spam emails, as identified by a user. It performs statistical analysis on both of sets of email to identify words most likely to appear strictly in spam email, and words most likely to appear strictly in non-spam email, in order to identify spam in incoming email messages. There is no specific code or database of words hand tailored by a programmer that indicates spam. Instead, a user identifies spam versus non-spam email, and analysis proceeds on the basis of shared versus unique words in the two sets of email. Paul Graham's Bayesian filtering technique has a success rate of better than 99.5% in discovering spam emails (i.e., less than 0.5% false negatives), and a false positive rate under 0.03%; a false positive is non-spam email identified as spam.

In the present invention Bayesian analysis applies to generalizing new Preferences from heavily preferred keywords. The goal is to determine the probability that a mobile Subscriber will consummate a proposed contact with another Subscriber, given the fact that the latter Subscriber is tagged with a given keyword or set of keywords. Keywords that are strongly correlated with Subscriber DBIDs that are frequently selected for contact when available form the basis for new, high-strength Preferences. Keywords that are strongly correlated with Subscriber DBIDs that are infrequently selected for contact when available form the basis for negative Preferences, which can take the form of ‘minus’ query subexpressions (i.e., negated query subexpressions), or the form of blocked Preferences with formulae using those undesirable keywords in non-negated expressions.

The Bayesian probability formula applied to generalization of Preferences in the present invention takes the following form:

P(selected|K)=(P(K|selected)×P(selected))/P(K)

This application of the Bayesian formula reads, “The probability that a proposed Subscriber DBID will be selected for communications, given the fact that the Subscriber is tagged with a keyword combination K, equals the product of ‘P(K|selected)’—the probability that keyword K combination is tagged to any previously selected Subscriber DBID—multiplied by ‘P(selected)’—the probability that a Subscriber DBID will be selected when made available for selection—divided by ‘P(K)’—the probability that keyword combination K is tagged to the Subscriber DBID being inspected.” Any keyword or combination of keywords K with a high probability above some threshold becomes the query formula for a Preference if such as Preference does not already exist for the originating Subscriber. Compound queries containing subexpressions connected by ‘and,’ ‘minus’ or ‘or’ are considered below, after an example of a simple keyword Preference.

The SelectedSet and InspectedSet of Subscriber DBIDs are defined for Bayesian Ranking as they are for Centile Ranking. In the present invention a Bayesian learning plugin code module records statistics such as those in the example Table 2 below as part of a Subscriber's database record.

TABLE 2
Keywords and selection status for example Establishments e1
through e10

| DBID | keywords tagged to DBID | selected? |
|---|---|---|
| e1 | food Italian | true |
| e2 | food Greek | false |
| e3 | food Chinese | false |
| e4 | food French | true |
| e5 | wine Italian | true |
| e6 | wine French | false |
| e7 | wine Italian | false |
| e8 | wine French | false |
| e9 | food wine beer German | true |
| e10 | beer | false |

Table 2 shows records for Establishments with DBIDs e1 through e10. The size of the InspectedSet in this small example is 10, one per Establishment inspected, and the size of the SelectedSet is 4 as given by the number of true “selected?” entries in the right column.

P(selected) is a simple scalar value of 0.4 in this example, which is the size of the SelectedSet divided by the size of the InspectedSet. It is the probability that any random, inspected Subscriber will be selected, without considering its keywords.

Table 3 shows P(K) and P(K|selected) for each individual keyword K in Table 2, along with the resulting P(selected|K) found using the Bayesian Formula.

TABLE 3
Keyword related probabilities for the data of Table 2

| keyword | P(K) | P(K\|selected) | P(selected\|K) |
|---|---|---|---|
| Food | 0.5 | 0.75 | 0.6 |
| Wine | 0.5 | 0.5 | 0.4 |
| Beer | 0.2 | 0.25 | 0.5 |
| Italian | 0.3 | 0.5 | 0.67 |
| Greek | 0.1 | 0 | 0 |
| Chinese | 0.1 | 0 | 0 |
| French | 0.3 | 0.25 | 0.33 |
| German | 0.1 | 0.25 | 1.0 |

The following formulas assist with an understanding of the numerical information presented, as an example, in Table 3:

P(K)=count of K in InspectedSet/size of InspectedSet=count of K in InspectedSet/10

P(K|selected)=count of K in SelectedSet/size of SelectedSet=count of K in SelectedSet/4

P(selected)=size of SelectedSet/size of InspectedSet=0.4

P(selected|K)=(P(K|selected)×P(selected))/P(K)=(P(K|selected)×0.4)/P(K)

Comparing the right column of Table 3 to selected keywords in Table 2, it is clear that a German-tagged Establishment was selected 100% of the times inspected, an Italian-tagged Establishment was selected two-thirds of the times inspected (roughly 67%), a food-tagged Establishment was selected 60% of the times inspected, and so on. Bayesian Ranking in the present invention uses the right column of Table 3 as the strength for a Preference query formula consisting of the keyword in the left column, forming a new Preference only when the strength exceeds some learning threshold parameter and such a keyword Preference does not already exist for the learning Subscriber. A typical implementation also places some lower bound on P(K) before forming a Preference for K, so that newly introduced keywords do not instantly become candidates for Preference formulae; K must distribute into a population of Subscribers, yielding some minimal P(K) value, before it becomes representative of a general Preference.

This Bayesian analysis applied to the present invention can also strengthen or weaken an existing keyword K Preference according to the formula previously given for Centile Ranking:

NewStrength=((OldStrength×DragFactor)+P(selected|K))/(DragFactor+1)

with P(selected|K) substituted for Centile Weight.

Pairwise query on two keywords joined by ‘and’ proceeds similarly over a table of combined keywords similar to Table 3. For example, the combination ‘K=food and Italian’ has P(K)=0.1, P(K|selected)=0.25, and P(selected|K)=1.0. The combination ‘K=wine and Italian’ has P(K)=0.2, P(K|selected)=0.25, and P(selected|K)=0.5. The combination ‘K=food and wine’ has P(K)=0.1, P(K|selected)=0.25, and P(selected|K)=1.0.

Pairwise query on two keywords joined by ‘minus’ (or equivalently, ‘not’) proceeds similarly to pairwise query on two keywords joined by ‘and,’ with ‘K=K₁ minus K₂’ satisfied whenever a Subscriber includes K₁ and does not include K₂ among its keyword tags. For example, the combination ‘K=food minus Italian’ (i.e., keyword “food” must be present and keyword “Italian” must not be present) has P(K)=0.4, P(K|selected)=0.5, and P(selected|K)=0.5.

Finally, pairwise query on two keywords joined by ‘or’ proceeds similarly to pairwise query on two keywords joined by ‘and,’ with ‘K=K₁ or K₂’ satisfied whenever a Subscriber includes K₁ or K₂ or both among its keyword tags. For example, the combination ‘K=food or Italian’ (i.e., keyword “food” or keyword “Italian” or both must be present) has P(K)=0.7, P(K|selected)=1.0, and P(selected|K)=0.57.

Like Centile Ranking, an advantage of Bayesian Ranking is the fact it is selective, differentiating keywords that are good predictors of Subscriber selections from other keywords. A common or rare keyword does not in itself predict likelihood of selection; Bayesian Ranking extracts a keyword's potential for being a good predictor of selection. More complex compound query formulae are possible using multiple subexpressions joined by ‘and,’ ‘or’ and ‘minus,’ although both the analysis and the application of these formulae in queries becomes more expensive.

The present exemplary implementation of Bayesian Ranking implements generalization by following all of a Subscriber's Associations to target Subscribers and collecting and ranking their keywords according to the Bayesian formulae of this section, selecting high strength keyword combinations, according to P(selected|K), as candidates for generalization into Preferences. It forms both single keyword Preferences and compound Preferences with keywords joined by the ‘and’ operation.

### Time, Subscriber Status and Prior Selections in Selection and Learning

Neither the inference mechanism nor the statistical learning mechanisms considered to this point take time of day, Subscriber schedules, or sequences of Subscriber communication selections into account. A few simple example usage scenarios show why these factors are important to inference and learning.

It is inappropriate for a production implementation of the present invention to propose contact with a dinner restaurant at 3 A.M. local time, unless of course the Subscriber in question has a habit of making dinner reservations at unusual hours.

Likewise, it is inappropriate for a production implementation of the present invention to propose contact with a dinner restaurant when the Subscriber in question has an alarmed status due to an emergency.

It is also typically inappropriate for a production implementation of the present invention to propose contact with a dinner restaurant when the Subscriber in question has recently eaten dinner in a restaurant contacted using the present invention. For some categories of target Subscribers, where a category is identified with one or more keywords, there should be a refractory period before the present invention proposes additional contacts with other category members.

There is a single underlying solution for these three limitations of the mechanisms described so far. It centers on extending the definition of keyword K in the discussion of Bayesian Ranking to include time of day, or Subscriber status, or the most recent selection made by the mobile Subscriber using the service of the present invention.

Keyword K as tested by inference and as recorded and analyzed by learning could include actual keywords tagged to target Subscribers along with time of day, and optionally day of week or similar time tags. For example, define K_{w} as a collection of Subscriber keyword subexpressions optionally joined by ‘and,’ ‘minus,’ or ‘or’ as explained in the discussion of Bayesian ranking, and K_{T} as time of day and/or day of week and/or other temporal indicators. The total keyword query string is now “K_{w} ‘at’ K_{T};” it searches for a logical combination of keywords at specific times.

Using a similar approach, define K_{S} as a set of Subscriber status values as defined in the discussion of class Subscriber for FIG. 1, e.g., StatusBusy, StatusAlarm, etc. The total keyword query string is now “K_{w} ‘in’ K_{S};” it searches for a logical combination of keywords for an originating Subscriber in one of a set of status states. Moreover, recall from the discussion of FIG. 1's status and schedule fields that objects of class Schedule and ScheduledEvent in the exemplary implementation of the present invention can set a Subscriber's status, constrained by a one-time or recurring schedule, using status priority to resolve Subscriber status when ScheduledEvents overlap in time. It is a simple extension to this exemplary implementation to have a ScheduledEvent object deliver both status and a list of context keywords in effect for this scheduled Subscriber. Using this extension, K_{S} consists of both a status set and context keywords set by a Subscriber's Schedule.

Finally, define K_{P} as the set of textual keywords tagged to the mobile Subscriber's prior set of selections made via the service of the present invention, within some parameter-constrained period of time. The total keyword query string is now “K_{w} ‘after’ K_{P};” it searches for a logical combination of keywords following some prior set of keywords. K_{P} could be further refined using the Bayesian analysis techniques already discussed. For example, expand Table 2 with an additional column showing “prior keywords tagged to DBID,” and similarly add another column to Table 3 showing “prior keyword.” Bayesian analysis now extracts “P(selected|K)=P(selected|K_{w} ‘after’ K_{P}).” Analysis is similar to compound query formulae already examined. “P(selected|K_{w} ‘after’ K_{P})” is an example of a first-order Markov chain; the probability of selection is dependent on keyword tags of potential Subscribers and the most recently selected target Subscribers.

Taken individually or together, K_{T}, K_{S} and K_{P} provides search context. An Association or Preference strength is determined partly by prior interactions, either explicitly by setting strengths in a Subscriber profile, or by learning (or both), and partly by context.

Define K_{C}, “keyword context,” as some combination of K_{T}, K_{S} and K_{P}. For the inference mechanism that finds prospective target Subscribers, the strength of Associations and Preferences can be a function of explicit configuration by an originating Subscriber, strength learning, and the originating Subscriber's context. There are at least three exemplary implementations of inference within the present invention that can use context information. In one exemplary implementation, every context-free Association or Preference strength—a context-free Association or Preference strength is a strength as defined and used in previous sections, without regard to context—becomes one or more context-dependent Association or Preference strengths by copying every context-free Association or Preference of an originating Subscriber into one or more Associations or Preferences, each of which is tagged with distinct context constraints as well as a context-dependent strength, and then sorting the associations and preferences lists according to context-dependent strength. The lazy inference mechanism proceeds as before, the difference being that there may now be many more Associations and Preferences to test after the originating Subscriber moves.

An alternative exemplary implementation of context-dependent strengths in inference that is more parsimonious in storage size and computation time does not increase the numbers of Associations and Preferences above their context-free number. Instead, it stores multiple context-to-strength mappings within each Association and Preference; the originating Subscriber's context provides a key for extracting a context-dependent strength from each Association and Preference, including transitive Associations. Recalling that the lazy inference algorithm requires lists of Associations and Preferences to be in sorted order by strength, the inference algorithm must sort a copy of every list of Associations and Preferences it uses according to context-dependent strength before using that list for inference.

The exemplary implementation of the present invention uses this alternative approach to context-dependent Association and Preference strengths. When a Subscriber's ScheduledEvent becomes current, it updates a set of context words tagged to the Subscriber's database record; a Subscriber (e.g., person, establishment, service, etc.) can also interactively update the set of context tags in its record. Inference, triggered by Subscriber movement, compares a Subscriber record's current set of context tags to the context-dependent strengths tagged to Associations and Preferences, using the strongest context held by both the Subscriber record and each Association or Preference being considered. Use of context-dependent strengths is optional. If there is no match between a Subscriber's context tags and the context-dependent strengths tagged to an Associations or Preference, or if the Subscriber, Association or Preference has its context properties disabled, then default, context-free strengths are used as originally discussed for inference.

A third exemplary implementation of context-dependent usage does not change Associations, Preferences or inference from their context-free form. Instead, it post processes the results of inference by classifying potential target Subscriber DBIDs into keyword-based categories according to context correlation, and then displays these Subscriber contacts on a terminal device grouped by category. Recall from the abstract of the present invention that, “The present invention presents a mobile user with a list of prospective subscribers and their advertised services to contact within the locale, sorted by strength and classified by keywords tagged to those subscribers' records.” It is the classification of the terminal display by keywords, and not the Association or Preference strength or Activation level within inference, that is effected by this third exemplary implementation. For example, once a mobile Subscriber has selected a dinner Establishment, the server mechanism notifies the handset that additional contacts residing in the “dinner ‘and’ restaurant” display category have lower display priority than potential contacts residing in the “dessert ‘or’ bar” display category. Such context priorities derive from statistical analysis of SelectedSet and InspectedSet choices, similar to the analysis for Association and Preference strength. But context information does not affect inference strength in this implementation; instead it affects filtering of the results of inference as presented on a terminal device.

In order to use context information, the learning mechanisms such as Centile Ranking or Bayesian Ranking must record and correlate context K_{C} of an originating Subscriber when the Subscriber picks a SelectedSet of target Subscribers to contact from an InspectedSet, as outlined previously. For the two exemplary implementations of context that use context-dependent strengths for Associations and Preferences, each Association or Preference leading to an InspectedSet or a SelectedSet is treated as multiple Associations or Preferences, one per context, during the statistical analysis processes. For the third exemplary implementation that uses context to organize and prioritize display categories, Centile Ranking, Bayesian Ranking or another statistical ranking algorithm that forms strongly correlated display categories based on sets of keys “K=K_{W} ‘in’ K_{C},” correlates SelectedSet entries to context-prioritized, keyword-based display categories. The server's post processing of the results of inference uses learned keyword-to-category correlations to report category membership and category context-dependent priority to the terminal device for display when reporting potential Subscribers for contact.

Before turning to specific examples with respect to the present invention, it is noted that one contemplated embodiment of the invention involves an apparatus for automated interaction between subscribers. For this embodiment, a detector detects location information about a subscriber.

The detector may be a GPS unit, as noted above, or any other suitable devices, as would be appreciated by those skilled in the art. The detector may also detect a non-geographic location of a user or a virtual locational space. In such an instance, since the space may not be a physical location, the detector may be a computer, PC, or other device capable of recognizing the non-geographic location of the subscriber. In the case of a personal computer and/or a server, the device detects, for example, the URL (or web address) accessed by the subscriber.

The apparatus contemplated for the present invention also is contemplated to include a receiver to receive outgoing information from a subscriber. The outgoing information may include association information, preference information, and strength information, as discussed above.

The strength information is related to at least one of the association information or the preference information and indicates a magnitude of the subscriber's preference for the association information or the preference information.

The apparatus also is contemplated to include a processor to correlate the outgoing information and the strength information with establishment information.

The establishment information is related to at least one establishment disposed at least within a predetermined location. The processor generates incoming information to the subscriber based on the correlation.

As would be appreciated by those skilled in the art, the apparatus also is contemplated to include a transmitter to transmit the incoming information to the subscriber.

### IV. Example Use Cases

This section illustrates use of the present invention via use cases and object diagrams. A use case is a concrete user scenario that uses the invention. An object diagram shows concrete objects of the concrete classes appearing in FIG. 1, i.e., objects of class Person, Establishment, Property, Association, Preference and ContainerPreference.

There are seven use cases described in connection with the invention. These use cases are intended to be exemplary only and not limiting of the invention.

Use Case 1: An Engineer Walks into a Bar.

A French engineer who has previously subscribed to a Social Contact Service walks into a bar in Las Vegas equipped with Bluetooth® wireless technology. His mobile phone rings using his social contact ring tone. The phone's display reveals that a college professor friend from Florida is in the back room. He clicks to initiate a call as he walks into the room, and they both laugh and terminate the call as he walks over to her table. He joins her and her professor colleague from Las Vegas at the table.

He has also subscribed to a Commercial Contact Service, which notifies the bartender that the newly arrived man in the back room is on his first trip to Vegas. When a waiter comes to the table a minute later, he welcomes the engineer to Vegas by offering him a complementary drink.

After introductions and a couple of drinks the Las Vegas professor offers to take the engineer sightseeing. Because this professor also uses the Social Contact Service, she appears in the engineer's phone as a friend of a friend in the same bar. The new acquaintances exchange phone numbers and other contact information by pressing “Accept” when queried by their phones.

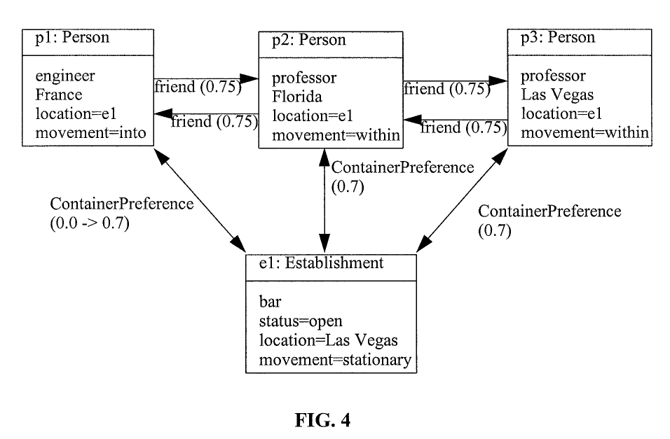

FIG. 4 is the object diagram for this use case. Before discussing the objects, object attributes and relationships of FIG. 4, it is useful to list a sequence of actions that occur when the engineer walks into the bar.

The object diagram alone does not capture these dynamic steps of inference, which are detailed below:

1. The engineer's walking into the bar and connecting to its Bluetooth network establishes a change in the proximity relationship. It is this change in the proximity relationship, and not the proximity itself, that initiates Activation of the objects in FIG. 4.

2. A strong Activation propagates between p1 and p2 because they share strong friend Associations and physical proximity. The inference engine detects the change in location of p1 and propagates it to all Subscribers with previous relationships to p1-p2 in this example—and to e1 because e1 defines p1's location. Even though p1 has no stored prior Association with e1, p1 and e1 have ContainerPreferences for creating an Association automatically with anyone entering the bar.

3. The transitive “friend of relationship of p1 to p3 would be of “medium” strength because transitive Associations grow weaker as activations cross multiple direct Associations. Note that if p2 were missing from the scene, the activation would nevertheless propagate from p2 to p3 as long as the level of activation meets some threshold established by subscriber p1. Assuming that a medium-strength activation meets this threshold, a medium transitive Association between p1 and p3 would be established.

4. Depending on the amount of historic data stored with p1, the bar might not be able to determine that p1 has never been to Las Vegas, but the combination of facts that p1 has never been in this bar before (based on e1's historical records) and p1's non-Nevadan home might be enough to trigger a “free drink” reaction by e1. If e1 has Associations with other bars in Las Vegas via the commercial service, it can determine more reliably that p1 has never bought drinks in Las Vegas, if records from those bars are available. This information would typically be available among bars with common owners, e.g., a chain of bars.

5. Shortly after the engineer joins the professors, his movement changes from “into” to “within” the bar, but the activated Subscribers remain visible on his cell phone. For example, he could call the bar if the waiter disappears for too long. In this use case he establishes a direct “friend of” Association with the Las Vegas professor, of lower strength initially. Using this Association repeatedly over coming days would increase its strength.

FIG. 4 shows keywords tagged to its Subscriber objects. Associations appear in FIG. 4 as single-direction links. ContainerPreferences appear as bidirectional links. Labels and strengths are tagged to these links.

In the use case of FIG. 4, the transitive “friend of friend” Association of 0.75×0.75=0.5625; crossing two strong friend Associations yields a medium friend Association. The inference system supplies default thresholds, and Subscribers can set their own levels of interest, below which Activations are treated as 0.0 and die out. Presumably, if all goes well between the French engineer and the Las Vegas professor, repeated Activations of their Association will strengthen it. When Activation contacts reported to their Subscribers are explicitly used by those Subscribers (e.g., by returning to an Establishment repeatedly or by exchanging phone numbers and contact information in this use case), the inference engine strengthens the Associations actually leading to the explicit action. When Subscribers do not act on Activations within short physical proximity (e.g., ignoring a friend), the inference engine weakens ignored Associations. Subscribers explicitly set Outgoing and Incoming Blocks.

The ContainerPreference of FIG. 4 is a specialized subclass of Preference, as discussed for FIG. 1, used to highlight a mobile Subscriber's immediate environment. When a mobile Subscriber enters an enclosing Establishment, the Subscriber's ContainerPreference spreads activation to the Establishment. Unlike an Association, a ContainerPreference is not bound to a specific target Subscriber, and unlike a more general Preference, a ContainerPreference does not match keywords to target Subscribers. Instead of querying keywords, it queries locational containment data structures maintained by concrete LocationAPI-derived objects. Furthermore, unlike other Preferences, ContainerPreferences are usually transitive. In FIG. 4 p1's ContainerPreference activates the bar with a strength of 0.7, and if the bar's ContainerPreference is configured to allow transitive inference, p1 could locate other Subscribers in the bar at a strength of 0.49 (0.7×0.7). In this particular use case p1 already has an Association with strength 0.75 to p2, and a transitive Association with strength 0.56 to p3, so those values dominate the transitive ContainerPreference strengths of 0.49. But in situation where there are no known, previously associated Subscribers or Subscribers with preferred keyword tags within a mobile Subscriber's containing environment, transitive ContainerPreferences help a mobile Subscriber connect with other Subscribers in the environment.

Use Case 2: A Businesswoman Walks Out of an Airplane and into an Airport.

A businesswoman's mobile phone notifies her of the availability of limo service in the transportation area. She, the airport and the limo companies subscribe to the Commercial Contact Service. The fact of her arrival in the airport in a terminal triggers the limo availability notification. The airport is equipped with Bluetooth® networking. The Service provides her with prices and phone numbers for available limo services.

The businesswoman's mobile phone also notifies her of the presence of an old corporate friend-turned-enemy in the airport via the Social Contact Service. She has blocked this enemy from seeing her movement in the Service, so he is not aware of her, but he has not blocked her, so she is aware of him. She no longer cares whether she sees this old enemy, but she does not want to see this notification again, so she now blocks seeing his movements with a button press. He cannot see her via the Service, and she no longer cares to see him via the Service.

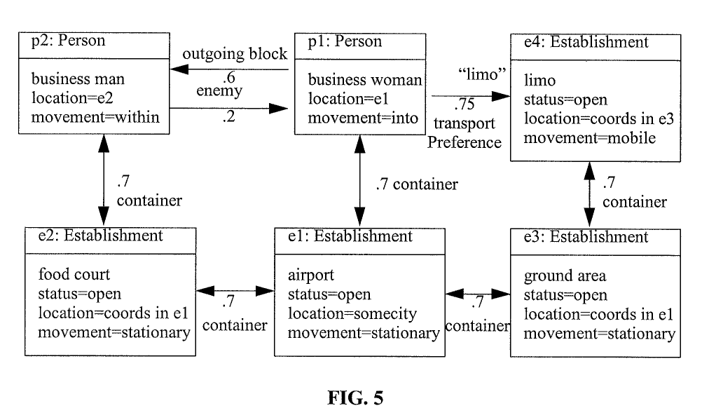

FIG. 5 is the object diagram for this use case. Labels on the person-to-person Associations are used to establish thresholds for inference. The inference system maintains default thresholds for unlabeled Associations or Associations whose labels do not match explicit thresholds.

This use case highlights the fact that locations within an Establishment can nest hierarchically. Both the food court e2 and the ground transportation area e3 lie within the airport e1. These three Establishments have strong Associations because of physical proximity and business relations. Person p2 has proximity Associations whose strength is derived transitively by containment. He is within e2 which is within e1, so his ContainerPreference of 0.7 with e2 is stronger than strength 0.49 for e1. Specific ContainerPreference objects could have custom strengths. Also ownership and membership Associations between the airport Establishments could have greater strengths.

A Preference for a transport-related service tagged with keyword “limo” leads to discovering the limo service when the businesswoman enters the terminal as her first location in the airport. The Preference is stored in her p1 object in the object database. It tests only mobile Establishments with strong physical proximity such as e4 here, setting up her 0.75 strength Association in FIG. 5.

Her Outgoing Block to enemy p2 inhibits delivery of notification about her arrival to p2, but her Association strength of 0.6 would allow news of p2's presence to reach her, if 0.6 is above her notification threshold. When she adds an Incoming Block from p2, the inference system will no longer deliver p2 information to her. The inference system might weaken the links to strength 0.0 at this point, but it leaves the explicit Blocks intact, i.e., it does not remove the Association.

### Use Case 3: A Traveler Approaches a Town in his Car.

His phone is equipped with Global Positioning Service (GPS). The time is late afternoon, approaching dinner time, and he and his companion have not stopped since noon. The phone brings up a sorted list of his favorite chain restaurants, along with some local restaurants, sorted according to his dining preferences. The companion reads off the first several entries, and they agree on one. When the companion selects that entry, the phone outlines directions and distance and begins giving detailed driving directions.

An object graph for this use case would use a number of Preferences, but it would introduce nothing new to inference. The main utility for this use case is GPS. There are Preferences that lead to a number of keywords tagged to restaurants in the area, ordered by strength.

Use Case 4: A Woman Walks into a Music Store.

An electric guitar that she has browsed on numerous occasions via the store's website is about to go on sale. A salesman greets her as she walks in the door, asks her if she'd like to try out the guitar, and offers to give her the sale price a day in advance.

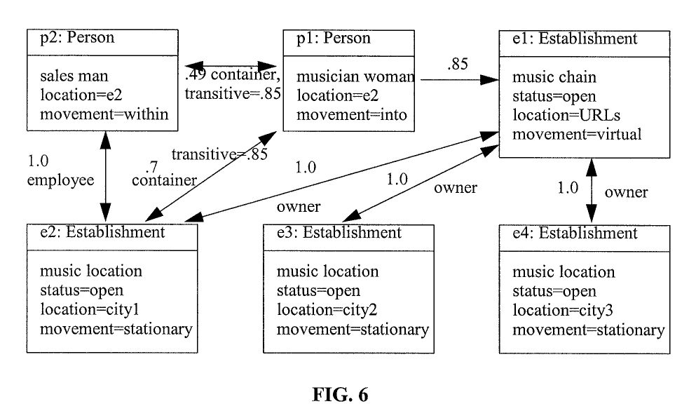

FIG. 6 gives the object graph for this use case, whose main contributions are URL-as-location, and the notion of a chain of stores. The underlying class diagram uses the Composite Design Pattern to represent a logical container, the music store chain in this example, that contains logical component objects, here the individual stores. Unlike the physical containment of the airport, containment here is logical. The woman can have an Association to the chain e1 via its URL that propagates to store e2 as she enters, alerting the salesman.

There are three pairs of Associations with strength 1.0 in FIG. 6 that are owner/owned containment Associations. The p1 woman's 0.85 prior Association to the store chain e1 via its URL propagates across the e1→e2 owner Association (×1.0) and the e2→p2 employer Association (×1.0) to give her temporary 0.85 Associations with e2 and p2. These temporary, transitive Associations outweigh default ContainerPreferences of 0.7 and 0.49 respectively. She may make these Temporary Association strengths permanent via a button press on her handset.

It would be possible to have an Outgoing Block to the containing chain and an unblocked Association to an individual store found to be acceptable. The explicit Association would bind more tightly to that store than the more general blocked Association.

It would also be possible to have an unblocked Association to the chain and an Outgoing Block to an individual store that is not acceptable. The more general explicit Association would bind more tightly to all stores except the store with the explicit Outgoing Block.

### Use Case 5: An Ambulance Pulls Up to a Man Passed Out in a Parking Lot.

The man has a recurring medical problem, and his pulse detector has caused his mobile phone to dial 911. The ambulance company receives a call with both the man's location and his medical condition and medications.

In this use case the man has both a location in Physical Space and a location in Health Space. Physical Space is the parking lot. Health Space is his physical condition. It is in the Health Space that movement occurs in this use case, going from Bad Health to Critical Health. Mobile inference triggers on Subscriber motion in one or more spaces, not limited to Physical Space. These spaces intersect and interact at Subscribers. In this use case the man's Health and Physical Locations intersect to generate notification that reaches the ambulance service (caused by change in Health) and to provide location information (current Physical Location records).

Use Case 6: A Thief Enters a Car with a Stolen Key and Drives Away.

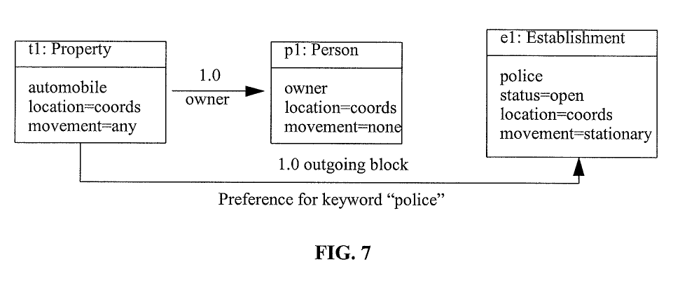

The car notifies the owner that the car is in transit, and optionally the police (when this feature is enabled), giving the car's Location periodically. See FIG. 7.

Here the GPS unit operates within a car that is a piece of Property, rather than being identified directly as a Person. The owner is a Person with a mobile phone. The police station is an Establishment. A general Preference for any police station would inform the Person of the closest one, but direct propagation of information to the police about the robbery would take place only when the Person lifts the Outgoing Block.

The present exemplary implementation of this use case limits permission for crossing the auto-to-owner link to the car itself, so that potential incoming activation to the car from the owner or other Subscribers does not propagate out. Also it disables transitive inference, so that propagation out from the car to the owner does not automatically propagate further.

### Use Case 7: Grandma Forgets to Take Her Medicine.

She is on a daily schedule. If she misses scheduled medication, her phone alerts her caretakers. When she takes her medicine, a button press on her phone triggers a one-time schedule for an event that overrides that day's alert.

This use case is similar to use case 5 as already discussed, activating Preferences and/or Associations for Temporal Alarm Space movement rather than Health Space. This use case introduces the construct of a Schedule into the architecture. A Schedule can be a recurring, periodic function of time or a one-time scheduled event. The general concept of scheduling here is similar to that used in automatic appointment calendars.

There are some aspects of Schedules that are unique to this architecture. Each ScheduledEvent has a Subscriber status such as off-line, available, or away that reflects the Subscriber's availability to the Service. Some ScheduledEvents entail notification of the user, similar to appointment calendars. However, some high priority ScheduledEvents entail generation of Alarm Space changes that propagate to other Subscribers, similar to the propagation of Health Space deterioration in Use Case 5. The exemplary implementation of the present invention uses a Temporal Location Space class to model 1D timelines and changes in time, and a derived Alarm Location Space to model entering an alarmed temporal location as a function of a ScheduledEvent. A ScheduledEvent with alarm status causes movement into an Alarm Location Space. This movement sends activation messages to target Subscribers connected by Associations or Preferences, notifying them of the alarmed state of the originating Subscriber, similar to movement into critical Health Space. At the top of the status priority ranking, a ScheduledEvent with cancel-alarm status overrides any other ScheduledEvent that occupies its time slot, thereby canceling a ScheduledEvent with alarm status. These mechanisms address this use case by scheduling a recurring alarm ScheduledEvent for each daily medication, then scheduling a non-recurring cancel-alarm ScheduledEvent each time Grandma takes her medicine.

Interaction with the exemplary implementation of the present invention suggests a number of restrictions on inference derived from movements in Health and Alarm Spaces, in order to limit the scope of target Subscribers who receive notification of emergencies. Without restrictions the architecture tends to notify every nearby associate of the Subscriber experiencing the emergency. While this degree of notification may be helpful in emergency situations where primary contacts be may unavailable, it is inappropriate to notify every Establishment that might be of interest for casual interactions, such as a restaurant or bar, when a mobile Subscriber has a medical emergency. A more focused approach is to have high priority Associations to a few friends, relatives, or emergency care providers who are aware of the Subscriber's condition, along with backup Preferences for high-availability services such as 911 calls. Work with the exemplary implementation has led to creation of the following, optional restrictions that can apply to any Association or Preference.

Permission of an Association or Preference may limit its activation to the owning Subscriber, so that it is only triggered by the owner's movement.

Non-transitivity of an Association or Preference may keep it from being used in “friend of a friend” (or in this case, “friend of an emergency service provider”) propagation path. A non-transitive Association or Preference propagates notification to its direct destination target Subscriber but no further.

A Subscriber may move in a hidden Location Space rather than in a global Location Space, such as a Health Space that is shared only by specific Subscribers or classes of Subscribers. A containment tree for such LocationAPI objects contains only the LocationAPI objects in the hidden space.

A Location Space class restriction tagged to an Association or Preference, when present, limits propagation to explicit Location Space universes. Health and Alarm Associations and Preferences can be restricted to movement in Health and Alarm Location Spaces. More mundane Physical and URL Associations and Preferences can be restricted to movement in Physical and URL Location Spaces. An unrestricted Association or Preference applies in all spaces. This mechanism allows notification about specific movement types to be focused towards specific types of target Subscribers.

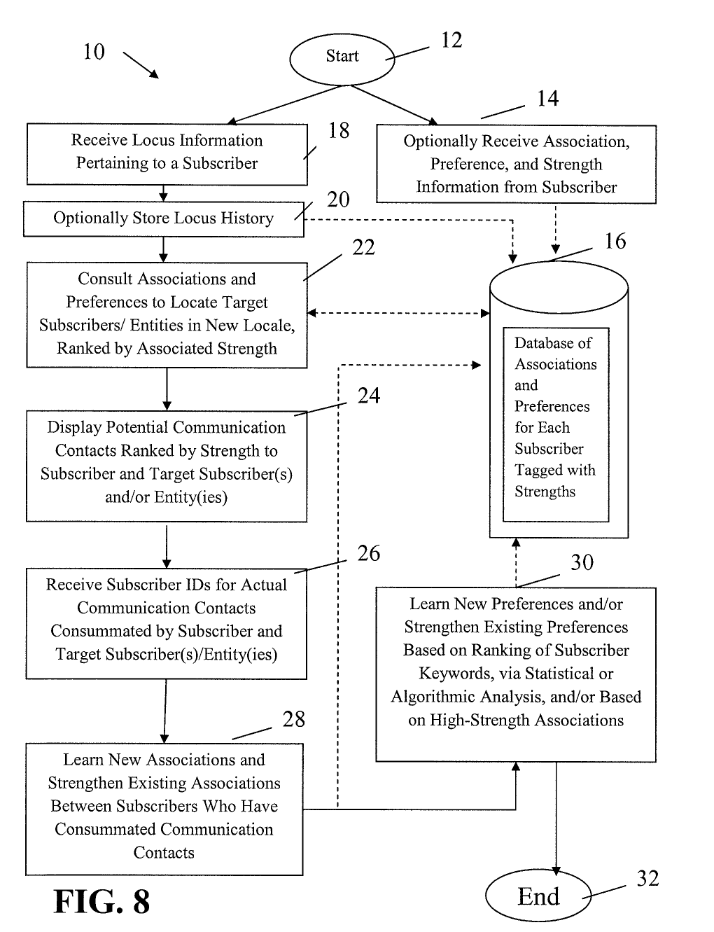

In connection with the invention, further aspects are now discussed. In particular, reference is made to FIG. 8, which provides a flow diagram summarizing one method contemplated by the invention. FIG. 8 provides a high-level overview of several features of the invention, as will be made more apparent below.

FIG. 8 illustrates a method 10 for automated interaction between entities. Entities include subscribers to a particular service. It is noted herein that a subscriber is a person who has enrolled in a particular service, such as Internet service, mobile telephone service, or the like. An entity is intended to encompass parties that may be subscribers or may not be subscribers. The term entity, therefore, is intended to be used more broadly. It is noted that the term subscriber and entity are both used throughout this discussion. In some cases, the terms may be employed interchangeably. In each instance, the terms are intended to encompass the most broad range of parties, whether entities or subscribers.

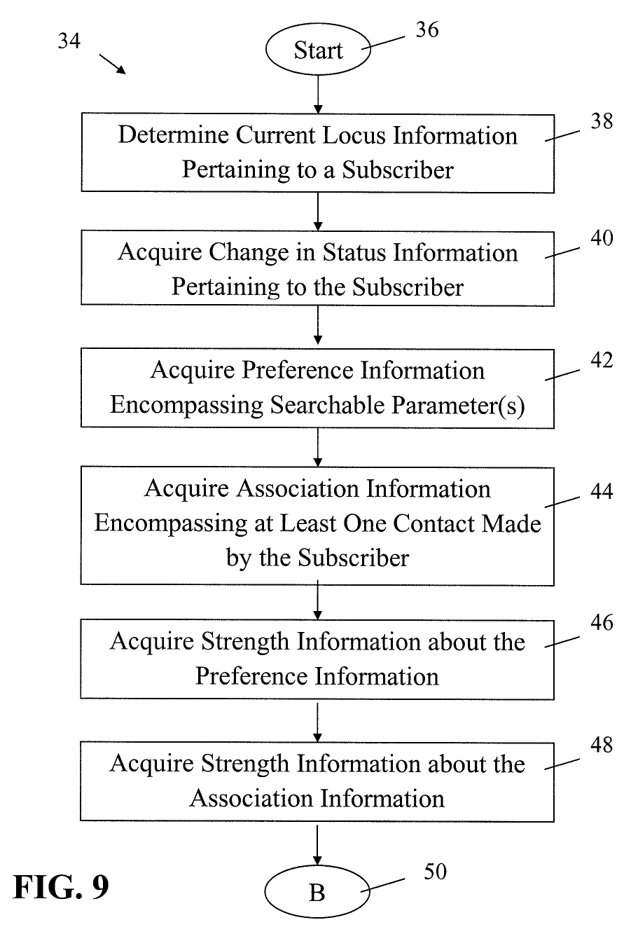

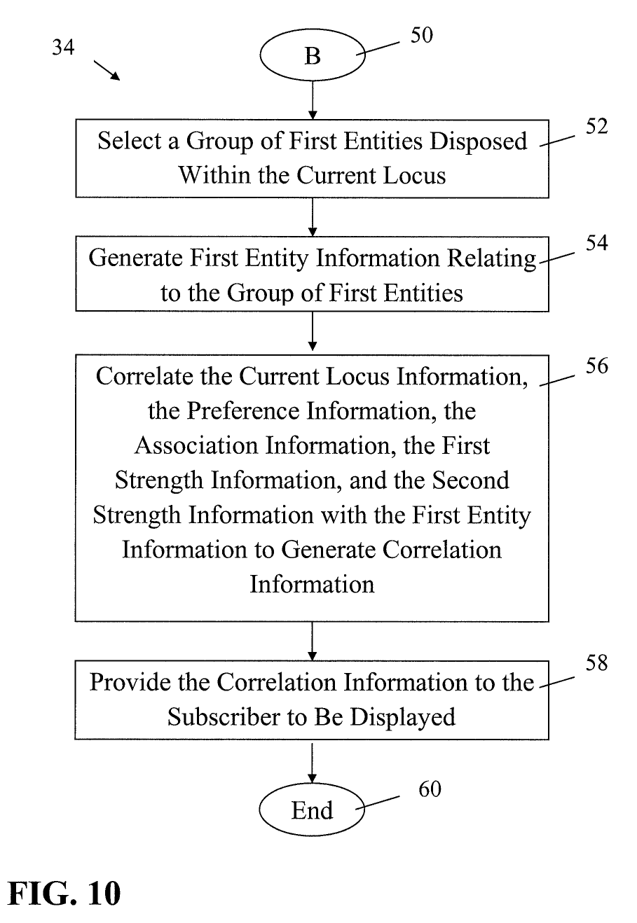

The method 10 begins at 12. At 14, a subscriber may explicitly enter data about one or more associations to entities or other subscribers, including one or more association strengths. In addition, at 14, the subscriber may enter data about preferences for keywords tagged to other subscribers or entities, including preference strengths. Data about associations and preferences are retained in a database at 16. The database may be local to the subscriber or may be physically positioned at a location remote from the subscriber. At 18, current locus information about a subscriber is received. The location locus includes, but is not limited to, a geographic area, a non-geographic area, or information about a virtual locational space. The term locus is discussed in greater detail in connection with FIGS. 9 and 10, below. At 20, a locus history of the subscriber optionally may be stored either locally or in the database 16. Storage of the locus history for the subscriber permits the method 10 to assign strengths to one or more loci previously visited by the subscriber independently of any data entered by the subscriber at 14, for example. In this way, the method 10 may “learn” strengths by analyzing the subscriber's prior behavior.

At 22, the method 10 retrieves, from the database 16, associations and preferences leading from the mobile subscriber to target subscribers or entities in or near the mobile subscriber's locus. Then, at 24, the method 10 displays potential subscriber-to-subscriber or subscriber-to-entity communication contact information. The contact information may be sent to the mobile subscriber, to the target subscriber and/or entity, or to both subscribers and entities, as desired. At 26, the method 10 receives identifiers for subscribers and entities who have actually consummated communication contacts based on the displayed potential communication contacts of step 24. Then, at 28, the method 10 “learns” new associations and/or strengthens existing associations between subscribers and entities who have consummated communication contacts with one another. Following this, at 30, the method 10 learns new preferences and/or strengthens existing preferences. The new associations and/or strengthened associations may be used as input parameters, at least in part, for the operation identified at 30. Specifically, at 30, the method 10 strengthens the preferences existing in the database 16 based on the new associations, high-strength associations, keywords generated based on the new associations, and/or keywords entered by the subscriber, among others. In addition, statistical and/or algorithmic correlations and/or calculations may be employed to establish the new preferences at 30. To calculate new strengths, the method 10 employs a statistical correlation that includes the frequency of consummated communications, among other factors. The method 10 then ends at 32.

Reference is now made to FIGS. 9 and 10, which details another method contemplated by the invention.

FIGS. 9 and 10 illustrate a method 34 that is executed on or is executable on a processor. The method 34 provides for automated correlation between a subscriber and at least one entity. For purposes of this discussion, a processor may be any type of equipment that executes instructions. For example, a processor may include a computer, a mobile communications device, a handheld computer, a personal data assistant, or the like. This list is not intended to be exhaustive of all of the possible types of equipment that may be considered to be a processor.

Returning to FIG. 9, the method 34 begins at 36. At 38, current locus information is determined. The current locus information includes at least an identity of a current locus in which the subscriber is disposed. It is noted that the term “locus” is intended to encompass geographic, non-geographical, and virtual locations, among others. The term “locus,” therefore, is not intended to be limiting. If the current locus is a geographical location, the information received by the method 34 may include positional information provided by a global positioning system (“GPS”) or a suitable equivalent. If the current locus information concerns a specific uniform resource locator (“URL”), the current locus information may be provided by a suitable algorithm associated with the Internet, for example. Other examples of what is meant by the term “locus” also are provided herein.

At 40, the method acquires a change in status information pertaining to the subscriber. The change in status information includes at least an indication that the subscriber has moved from a previous locus to the current locus. It is noted that the change in status information may encompass a change in geographic location, non-geographic location, or virtual location. Since one non-geographic location is time, the change in status information might indicate that the subscriber has entered into a time period encompassing, for example, the dinner meal. The method 34 may be designed so that the method then searches for restaurants in the subscriber's immediate geographic locus. Of course, many other variations are possible and are intended to fall within the scope of the invention.

At 42, the method 34 acquires preference information. The preference information includes at least one searchable parameter selected by the subscriber. It is noted that the searchable parameter may be one that is currently selected or may be a parameter searched by the subscriber at an earlier time.

Then, at 44, association information is acquired. The association information encompasses at least one contact made by the subscriber.

At 46, the method 34 proceeds to acquire first strength information. The first strength information encompasses a magnitude of the subscriber's affinity for the preference information.

At 48, the method 34 proceeds to acquire second strength information. The second strength information encompasses a magnitude of the subscriber's affinity for the association information.

Reference numeral 50 refers to the transition block B in FIG. 9. The transition block 50 provides a connector to the remainder of the method 34 that is illustrated in FIG. 10.

With reference to FIG. 10, the method 34 continues to 52, where a group of first entities are selected. The group of first entities are disposed within the current locus. Moreover, the group of first entities are selected in response to the change in status information.

At 54, first entity information relating to the group of first entities is generated. The group of first entities may encompass establishments, such as restaurants, in the current locus of the subscriber. Therefore, if the change in status information indicates that the subscriber is hungry, for example, the method 34 will initiate a search for food options in the current locus of the subscriber. As should be apparent the first entity information may encompass a wide variety of different types of information. For example, the first entity information might include a URL, a telephone number, or an address. The first entity information might also include, in the case of a restaurant, an indication of the type of food prepared by the particular restaurant. Alternatively, the first entity information might include a full menu. The number of possible types of information in this category are quite expansive.

At 56, the method 34 proceeds to correlate the current locus information, the preference information, the association information, the first strength information, and the second strength information with the first entity information to produce correlation information. It is noted that these four types of information provide at least a few limitations for the method 34. Without these parameters, the method 34 might consume a large amount of processor time, because the method 34 might be required to search a large number of variables associated with the subscriber before generating the correlation information. The correlation information includes a calculated assessment of a relevance of the first entity information to the subscriber.

Next, the method 34 proceeds to 58 where the correlation information is provided to the subscriber to be displayed.

The method 34 ends at 60.

With respect to the acquisition of the current locus information, it is contemplated that this information will be made available from a suitable GPS system, database, or the subscriber. The current locus also may be available through other avenues as well. With respect to the change in status information, it is contemplated that this information will be retrieved from a database or will result from a computation that is either a part of or in communication with the invention. Of course, those skilled in the art should readily appreciate that there are still further sources for this information.

Turning to the preference information, the association information, the first strength information, and the second strength information, there are a number of possible sources for this information. The information may be inputted from the subscriber. The information may be retrieved from a database. The information may be the result of a calculation or of a statistical analysis, for example. Other sources of the information also are contemplated to fall within the scope of the invention.

As indicated in FIG. 8, it is contemplated that the preference information, the association information, the first strength information, and the second strength information will be retrieved from a database, possibly the same database. It is contemplated that this may be the source of the information in every instance since the information received from the subscriber or resulting from a calculation is likely to be stored to a database before being used further. It is noted that the term database may encompass one or more databases without departing from the scope of the invention.

It is noted, at least in connection with FIG. 8, that the correlation information is expected to be displayed to the subscriber in one fashion or another. For example, where the subscriber is a mobile communication's user, the correlation information may be displayed on the screen of the subscriber's handheld device. Alternatively, the correlation information may be provided to any other suitable device, as should be appreciated by those skilled in the art.

As noted above, the preference information may be provided by the subscriber at 14. Alternatively, the preference information may be provided at 22. For the invention, it is contemplated that both options will operate at any given time. To assist with an understanding of this feature, the following additional information is provided.

In one example, preference information is selected by the subscriber. In this example, the preference information may encompass a query entered by the subscriber.

The method 10, 34 also is intended to operate without any input from the subscriber. So that the method 10, 34 is provided at least with some minimal input, the provider of the service, such as a mobile phone company, may establish an account for subscriber that contains an initial preference list. The initial preference list may simply include the name of the mobile provider and the home town of the subscriber. It is, of course, expected that further information will be included in the provider-selected preferences.

As noted above, the methods 10, 34 optionally may include storing a locus history for the subscriber. The locus history may include the identity of at least one previous locus visited by the subscriber. If this information is retained by the method 10, 34, a frequency with which the at least one previous locus is visited by the subscriber may be assessed. In addition, locus history strength for the locus history may be generated based at least on the frequency. Finally, the locus history strength may be incorporated into the second strength information.

In line with the retention of a locus history, the method 10, 34 also contemplates retaining a preference history and an association history. Like the locus history, the preference and association histories may be evaluated according to the frequency that the preferences or associations are used. The strengths of these preferences and associations may be increased or decreased depending upon the frequency.

Specifically, in one contemplated embodiment, a preference history may be stored as preference information. The preference history may encompass at least one previous parameter searched by the first subscriber. In this embodiment, the frequency with which the at least one previous parameter is searched by the first subscriber may be assessed by the method 10, 34. Once assessed, preference history strength for the preference history may be generated based at least on the frequency. Finally, the preference history strength may be incorporated into the first strength information to adjust the first strength information.

In still another contemplated embodiment of the invention, an association history may be stored as association information. The association history is contemplated to encompass at least one previous contact made by the subscriber. As with the prior embodiments, the frequency with which the at least one previous contact is established by the subscriber is assessed. Next, association history strength for the association history is generated based at least on the frequency. Then, the association history strength is incorporated into the second strength information.

In another contemplated embodiment of the invention, the first entity information may include contact information for one from the group of first entities. As should be apparent, the contact information may enable the subscriber to establish contact with one from the group of first entities.

In still another variation contemplated for the invention, a future locus of the subscriber may be taken into account by the method 10, 34. In this contemplated embodiment, the subscriber may enter a future locus or the method may determine a likely future locus based on movement of the subscriber. If the subscriber enters the future locus via an input device (such as a keypad), the method 10, 34 may react by searching for a group of second entities in the future locus. Alternatively, the method 10, 34 is contemplated to receive input from equipment that detects if the subscriber moves from the control area of one cell tower to another, at least in the mobile phone context. In this instance, a change in cell location may be used to establish the future locus of the subscriber.

In the variation where the future locus is employed, the method 10, 34 may be modified as follows. Specifically, the method 10, 34 may receive future locus information from the subscriber. The future locus information may include an identity of a future locus into which the subscriber is moving. Once received, change in status information may be updated. The change in status information is contemplated to encompass at least an indication that the subscriber is moving from the current locus into the future locus. A search for a group of second entities is then initiated in response to the generation of the change in status information. The group of second entities is expected to be disposed within the future locus. Then, the future locus information, the preference information, the association information, the first strength information, and the second strength information are correlated with the second entity information to generate correlation information, which is provided to the subscriber.

As should be apparent from the discussions above, it is contemplated that the subscriber is a mobile subscriber while at least one of the first or second entities is stationary. This particular embodiment, therefore, encompasses a situation where the subscriber is a mobile cell phone subscriber and at least one of the first or second entities is an establishment, such as a restaurant or other business, a property, a server, etc. As should be appreciated by those skilled in the art, the invention is not limited to these embodiments alone. To the contrary, the invention also contemplates that both the subscriber and one of the first or second entities are mobile subscribers.

In still another contemplated embodiment, the method 10, 34 of the invention is expected to calculate movement information of one user with respect to another. In this embodiment, the positions of two entities with respect to one another may be taken into account. In this variation of the method 10, 34, movement information is calculated. The movement information indicates at least one of a movement of the subscriber towards at least one from the group of second entities, or a movement of the subscriber away from at least one from the group of second entities. The movement information may be based on the current locus information, the future locus information, and the change in status information, among other factors.

As should be apparent to those skilled in the art, one aspect of the invention involves the automation of the method 10, 34 based on one or more parameters. For example, in one contemplated variation, the method 10, 34 may execute automatically, thereby initiating a search for the group of first entities, based at least on the movement information.

In a commonly-enabled embodiment of the invention, it is contemplated that the subscriber will be a person and that the group of first entities will encompass persons, establishments, properties, or servers. In the case where the one of the first entities is a server, it is contemplated that the server will be of any type used for the Internet or any other type of data communication. This, of course, encompasses any data servers that may be employed with respect to wireless communication, whether terrestrial or satellite-based.

As the foregoing discussion makes apparent, associations and preferences are related to one another. In one definition, an association is a direct link between two entities. For example, if the subscriber calls a contact with a cell phone, this establishes an association from the subscriber to the first entity. Assume that the first entity is a particular type of person, such as an attorney. If the subscriber calls a number of attorneys within a particular location, each of the individual calls form separate associations. In addition, the method 10, 34 eventually establishes preferences by the subscriber for this particular type of person based on the subscriber's usage history. In other words, associations may lead to preferences. The specific contacts, therefore, lead to general search parameters. This is referred to, in the art, as a “generalization.” The opposite also may occur. General search parameters, which are preferences herein, may lead to associations. This is referred to as “specialization.” The present invention contemplates both learning processes for the method 10, 34.

Since associations and preferences are, to an extent, interchangeable under this approach, the method 10, 34 of the invention assigns the same variables to both types of information. Specifically, association and preference information are expected to encompass at least some of the following variables: (1) subscriber identification information, which includes information about the subscriber, (2) label information, which encompasses the subscriber's activation threshold for an association or a preference, (3) proximity information, which may include information concerning the subscriber's proximity to the current location, (4) movement information, such as the subscriber's movement with respect to the current locus, (5) blocking information, which concerns whether second information is blocked from receipt by the subscriber or current locus information is blocked from transmission by the subscriber, (6) permission information, which involves the subscriber's permission to receive correlation information or transmit current locus information, and (7) location class universe information, which encompasses information concerning the applicability of the association or the preference to the current locus. Other types of information may be included in associations and preferences. These seven examples are intended to be merely illustrative of this aspect of the invention.

For the method 10, 34 of the invention, there are two examples of strength information. The first strength information is intended to be a first numerical identifier of the subscriber's affinity for the preference information. The second strength information is intended to encompass a second numerical identifier of the subscriber's affinity for the association information. These two strengths are expressed as numbers, which facilitates calculation by the processor of the various types of information required by the method 10, 34. As should be appreciated by those skilled in the art, other examples of strength information may be employed without departing from the invention.

The invention also is intended to relate to an embodiment where the preference information comprises container preference information. In the context of the invention, the container information is intended to be a temporary association with the subscriber while in the current locus. As discussed above, the container information may be employed when the subscriber enters a hardware store, for example. The hardware store, which is one of the first entities, may desire to transmit to the subscriber information concerning specials in the store. The container preference information is ideally suited for this task. Once the subscriber exits the establishment, the container information may be deleted.

Separately, the container preference information may lead to an association with the establishment. Alternatively, if the subscriber visits enough of the same type of establishments, a preference may develop over time.

Since the subscriber and the group of first entities are capable of communicating with one another via the method 10, 34, issues of security and of privacy become a concern. Therefore, in one contemplated embodiment of the invention, the method 10, 34 includes receiving security information from the subscriber and limiting receipt of the correlation information by the subscriber based on the security information. In addition, the method 10, 34 contemplates receiving privacy information from the subscriber and limiting transmission of information from the subscriber based on the privacy information. As may be appreciated by those skilled in the art, other variations also may be employed without departing from the invention.

The method of the invention also contemplates that a subscriber may occupy two locations at the same time, especially because the invention is not limited solely to geographic locations. For example, it is contemplated that the subscriber may occupy a specific geographic location and, simultaneously, to occupy a non-geographic location. In one contemplated embodiment, the subscriber may occupy a health space. In the context of a health space, if the health of the subscriber deteriorates such that it falls below a predetermined threshold, the method 10, 34 may notify one or more contacts (or associations). Since the subscriber also occupies a geographic space, the method 10, 34 may notify those associations that are closest to the subscriber before notifying others of the associations. In this manner the two spaces may cooperate with one another.

It is also contemplated that the subscriber may have available to him or her two separate electronic devices. For example, the subscriber may have a cell phone and an Internet browser. The method 10, 34 of the invention is contemplated to coordinate between the two separate devices. In one example, the subscriber may search the Internet for a local restaurant. The method 10, 34 may use the cell phone to determine the subscriber's geographic location and use the preferences (i.e., the search parameters) entered into the search engine on the Internet to provide a list of ranked restaurants in the subscriber's immediate vicinity. Other variations are also contemplated to fall within the scope of the invention.

Additionally, the method 10, 34 may encompass reception or calculation of proximity data with respect to the relative positions of the subscriber and the group of first entities. For example, the method 10, 34 may receive location information from the subscriber and the first entities and calculate proximity of the subscriber to one or more of the first entities. If so, the correlation information may be ranked using the proximity information in addition to at least one of the first strength information or the second strength information.

As before, the method 10, 34 is anticipated to automatically initiate a search for the group of first entities. In this particular example, the search is initiated based at least on the proximity information.

Since proximity is a relative term, the method 10, 34 contemplates that the subscriber may set the boundaries that help to define proximity. In a common example, the subscriber may establish a near boundary and a far boundary. The determination of proximity may then be determined by the method 10, 34 based on the near and far boundary parameters.

These near/far boundary parameters may be adjusted based on the geographic location of the subscriber, either automatically or manually by the user. For example, if the subscriber is searching for a restaurant in a geographically remote area, the near/far boundaries may need to be set in terms of tens of miles. However, in an urban environment, the near/far boundaries may be set in terms of hundreds of feet, for example.

As should be immediately apparent to those skilled in the art, different entities are expected to establish different parameters for near/far boundaries depending upon the type of the entity. For example, where the entity is a person, the person may set very narrow (or small) ranges for the near/far boundaries. However, where the entity is a business wishing to attract as many persons as possible, the entity is expected to establish a larger range for the near/far boundaries.

With respect to transmitting the identity of the subscribers and/or entities to one another, the invention contemplates that the identity of the first group of entities will be sent to the subscriber. In addition, it is contemplated that the identity of the subscriber may be sent to the one from the first group of entities.

The invention also contemplates that the information retrieved by the method 10, 34 may be sorted according to a number of different parameters. In one sorting scheme, it is contemplated that the method 10, 34 sorts at least one of the association information or the preference information based on the strength information related thereto. The method 10, 34 then compares the association information with the preference information based on the strength information related thereto. Finally, the method 10, 34 generates an activation based upon the comparison, wherein the activation defines parameters for sending the correlation information to the subscriber.

The method 10, 34 of the invention also contemplates that the sorting, comparing, and generating operations are repeated from the highest strength information to the lowest strength information. In one variation, the sorting comparing, and generating operations are at least partially performed according to a Dijkstra algorithm, which is known in the art.

Since it is expected that the first subscriber will not want all of the results of a search, a threshold limit may be received from the subscriber. The first or second strength information may then be compared with the threshold limit. The second information may then be transmitted to the subscriber if the first or second strength information exceeds the threshold limit. In this fashion, only the most highly ranked of the results are presented to the subscriber.

The method 10, 34 also may be established such that the correlation results in the generation of a data set that represents the intersection of the association information, the preference information, and the first entity information.

In still another variation of the method 10, 34, it is contemplated that strength adjustment information may be generated. Strength adjustment information concerns selections or inspections made by the subscriber of objects within at least one of the association information or the preference information. The strength adjustment information may be used to update the first or second strength information based upon the strength adjustment information. In this fashion, the method 10, 34 updates the strength information for the subscriber. As a result, the method 10, 34 continually updates and improves the strengths for the associations and preferences for a particular subscriber as the subscriber uses the method of the invention.

One embodiment of the invention contemplates the use of centile ranking for sorting of the results of a particular query. The centile ranking may be application to at least one of the association information or the preference information based at least upon at least one of the first or second strength information. The method also contemplates the use of Bayesian statistical analysis of at least one of the association information or the preference information based on key words related to the association information and the preference information. Other methodologies may be employed without departing from the scope of the invention, as should be appreciated by those skilled in the art.

In still another variation of the invention, the method 10, 34 is contemplated to receive time information. The method 10, 34 will then assess the time in connection with the correlation before generating the correlation information.

As should be apparent from the discussion above, the invention also contemplates that at least one of the association information or the preference information may be limited by the current locus of the subscriber. Other limitations also may apply.

The invention also contemplates, as a part of the iterative learning process of the method 10, 34, that certain information, referred to as “garbage,” may be removed from the search parameters if certain conditions are met. This assists the method 10, 34 to ignore parameters that are no longer of interest to the subscriber.

For example, in one contemplated embodiment, the method establishes a garbage threshold for the subscriber. The first or second strength information is then compared with the garbage threshold. Selected association or preference information is then removed from the correlation, if the first or second strength information falls below the garbage threshold. In another embodiment, association or preference information is deleted from the database associated with the subscriber, if the first or second strength information falls below the garbage threshold. The comparison of the first or second strength information with the garbage threshold may be performed via centile ranking, among other techniques.

The method 10, 34 of the invention also contemplates that it may be prudent to “slow” the rate at which strengths of the associations and preferences are changed. Specifically, in cases where there is a small amount of statistical information about a particular preference or association, sudden activity in a search area may cause one or more preferences or associations to be classified as garbage when this is not the intent or desire of the subscriber. Accordingly, the method of the invention introduces a “drag factor” that slows the rate at which the strengths associated with associations and preferences may be changed.

In accordance with this concept, the method 10, 34 contemplates receipt of a drag factor. The strength adjustment information may be generated with reference to the drag factor. The first or second strength information related to at least one of the association information or the preference information will then be updated based upon the strength adjustment information. The drag factor limits the extent to which the first and second strength information is updated by the strength adjustment information.

Another embodiment of the invention contemplates that status information may be computed with respect to the subscriber. The status information at least encompasses a prior history of the subscriber with respect to the association information, the preference information, and the time. A search may be automatically initiated for the group of first entities based at least on the status information and the time.

Not only may searches be initiated when the subscriber enters into a location occupied by the first entities, but searches also may be initiated when one from a group of first entities enters into a current space of the subscriber. In this contemplated embodiment, the method 10, 34 receives an indication that a first entity has entered the current locus of the subscriber. The method 10, 34 automatically initiates a correlation in response to the indication that the first entity has entered the current locus of the subscriber.

As noted above, preferences may be created based on multiple associations. In this embodiment, the method 10, 34 includes evaluating the second strength information. If the magnitude of the second strength information exceeds a predetermined strength threshold, the preference information may be modified to include a parameter encompassing the association information.

As should be appreciated by those skilled in the art, processors may be multithreaded. The processor that executes the method 10, 34 of the invention is not an exception. In a case where the processor is multithreaded, a single thread from a plurality of threads may be dedicated to at least one subscriber.

The invention also contemplates an architecture for automated interaction between entities. The architecture includes a location server associated with a location comprising at least one of a geographic area, a non-geographic area, or a virtual locational space, wherein the location server determines a subscriber's proximity to the location and generates location information. The architecture also includes an inference server in communication with the location server, wherein the inference server receives subscriber objects from the subscriber and creates a set of activation objects based on the location information and the subscriber objects. The may receive preference information from the subscriber and generates the set of activation objects based on the preference information.

The invention also contemplates an apparatus for automated interaction between a subscriber and at least one entity. The apparatus includes a detector to detect location information about an entity, wherein the location information comprises at least one of a geographic area, a non-geographic area, or a virtual locational space. It also includes a receiver to receive information from a subscriber comprising association information, preference information, and strength information, wherein the strength information related to the association information and the preference information and indicates a magnitude of the subscriber's respective preference for the association information and the preference information. A processor correlates the strength information with information from an entity, wherein the entity is disposed in or near the location, and to generate second information based on the correlation. Finally, the apparatus includes a transmitter to transmit the second information to the subscriber for display to the subscriber.

As may be appreciated by those skilled in the art, there are numerous variations and equivalents to the embodiments described herein. The invention is not intended to be limited to the specific embodiments described herein. To the contrary, the invention also is intended to encompass the variations and equivalents of these embodiments.

What is claimed is:

1. A method executed on a processor for automated correlation between a subscriber and at least one entity, comprising:
determining current locus information comprising at least an identity of a current locus in which the subscriber is disposed;
acquiring change in status information comprising at least an indication that the subscriber has moved from a previous locus to the current locus;
acquiring preference information comprising at least one searchable parameter selected by the subscriber;
acquiring association information comprising at least one contact made by the subscriber;
acquiring first strength information comprising a magnitude of the subscriber's affinity for the preference information;
acquiring second strength information comprising a magnitude of the subscriber's affinity for the association information;
responsive to the change in status information, selecting a group of first entities disposed within the current locus;
generating first entity information relating to the group of first entities;
correlating the current locus information, the preference information, the association information, the first strength information, and the second strength information with the first entity information to produce correlation information comprising a calculated assessment of a relevance of the first entity information to the subscriber; and
providing the correlation information to the subscriber to be displayed.

2. The method of claim 1, further comprising:
ranking the correlation information based upon at least one of the first strength information and the second strength information before providing the correlation information to the subscriber.

3. The method of claim 1, wherein the group of first entities includes the at least one contact.

4. The method of claim 1, wherein at least one of the preference information, the association information, the first strength information, and the second strength information are inputs from the subscriber and are stored to a database.

5. The method of claim 1, wherein at least one of the preference information, the association information, the first strength information, and the second strength information are inputs from a database.

6. The method of claim 1, wherein at least one of the preference information, the association information, the first strength information, and the second strength information are inputs resulting from a calculation.

7. The method of claim 1, wherein the current locus and the previous locus are at least one of a geographic area, a non-geographic area, and a virtual space.

8. The method of claim 7, wherein:
the geographic area comprises a two-dimensional geographic region;
the non-geographic area comprises at least one of
a health locus comprising a health status of the subscriber,
a temporal locus comprising a time, and
an alarm locus comprising a notification to the subscriber upon satisfaction of a predetermined condition; and
the virtual space comprises a uniform resource locator.

9. The method of claim 1, wherein the preference information comprises at least one of preferences selected by the subscriber and preferences selected by a provider of communication services to the subscriber.

10. The method of claim 1, further comprising:
storing, as association information, a locus history, wherein the locus history comprises an identity of at least one previous locus occupied by the subscriber;
assessing a frequency with which the at least one previous locus is visited by the subscriber;
generating a locus history strength for the locus history based at least on the frequency; and
incorporating the locus history strength into the second strength information.

11. The method of claim 1, further comprising:
storing, as preference information, a preference history, wherein the preference history comprises at least one previous parameter searched by the subscriber;
assessing the frequency with which the at least one previous parameter is searched by the subscriber;
generating a preference history strength for the preference history based at least on the frequency; and
incorporating the preference history strength into the first strength information.

12. The method of claim 1, further comprising:
storing, as association information, an association history, wherein the association history comprises the at least one contact;
assessing the frequency with which contact is made with the at least one contact by the subscriber;
generating an association history strength for the association history based at least on the frequency; and
incorporating the association history strength into the second strength information.

13. The method of claim 1, wherein the first entity information further comprises contact information, which enables the subscriber to establish contact with at least one from the first group of entities.

14. The method of claim 1, further comprising:
receiving future locus information comprising at least an identity of a future locus into which the subscriber is moving;
incorporating into the change in status information at least an indication that the subscriber is moving from the current locus into the future locus;
responsive to the change in status information, selecting a group of second entities disposed within the future locus;
generating second entity information relating to the second group of entities; and
correlating the future locus information, the preference information, the association information, the first strength information, and the second strength information with the second entity information to produce the correlation information.

15. The method of claim 1, wherein:
the subscriber is mobile; and
at least one from first group of first entities is stationary.

16. The method of claim 1, wherein:
the subscriber and at least one from the group of first entities is mobile.

17. The method of claim 14, further comprising:
calculating movement information, wherein the movement information indicates at least one of a movement of the subscriber towards at least one from the group of second entities, and a movement of the subscriber away from at least one from the group of second entities based at least on the current locus information, the future locus information, and the change in status information.

18. The method of claim 17, further comprising:
automatically initiating a search for the group of first entities based at least on the movement information.

19. The method of claim 1, wherein:
the subscriber is a person; and
the group of first entities comprises at least one of a person, an establishment, a property, and a server.

20. The method of claim 1, wherein the association information and the preference information share the same fields, comprising:
subscriber identification information, which comprises information about the subscriber;
label information, which comprises the subscriber's activation threshold for an association or a preference;
proximity information, which comprises information concerning the subscriber's proximity to the current locus;
movement information, which comprises information concerning the subscriber's movement with respect to the current locus;
blocking information, which concerns at least one of whether information is blocked from receipt by the subscriber and information is blocked from transmission by the subscriber;
permission information, which concerns the subscriber's permission to receive information or to transmit information; and
location class universe information, which concerns the applicability of the association or the preference to the current locus.

21. The method of claim 1, wherein:
the first strength information comprises a first numerical identifier of the subscriber's affinity for the preference information; and
the second strength information comprises a second numerical identifier of the subscriber's affinity for the association information.

22. The method of claim 1, wherein the preference information comprises container preference information, which comprises information concerning a temporary association with the subscriber while in the current locus.

23. The method of claim 1, further comprising:
receiving security information from the subscriber; and
limiting receipt of the correlation information by the subscriber based on the security information.

24. The method of claim 1, further comprising:
receiving privacy information from the subscriber; and
limiting transmission of information from the subscriber based on the privacy information.

25. The method of claim 1, wherein the current locus comprises at least two loci.

26. The method of claim 25, wherein one of the at least two loci is a geographic area and the other is a non-geographic area or a virtual space.

27. The method of claim 8, wherein:
the current locus comprises the health locus and the alarm locus, and
if a health status of the subscriber deteriorates below a threshold value, the alarm locus transmits an alarm to at least one contact in the association information.

28. The method of claim 1, further comprising:
receiving first entity locus information from at least one from the group of first entities; and
calculating proximity information comprising a proximity of the subscriber to at least one from the group of first entities.

29. The method of claim 28, further comprising:
ranking the correlation information using the proximity information in addition to at least one of the first strength information and the second strength information.

30. The method of claim 28, further comprising:
automatically initiating a search for at least one from the group of first entities based at least on the proximity information.

31. The method of claim 30, further comprising:
establishing a near boundary and a far boundary to define the proximity information.

32. The method of claim 31, wherein the subscriber establishes the near and far boundaries.

33. The method of claim 31, wherein at least one from the group of first entities establishes the near and far boundaries.

34. The method of claim 1, further comprising:
transmitting at least an identity of the subscriber to at least one from the group of first entities.

35. The method of claim 32, wherein the boundaries comprise distances around the subscriber.

36. The method of claim 1, wherein the correlation comprises:
sorting at least one of the association information and the preference information based on the strength information related thereto;
comparing the association information with the preference information based on the strength information related thereto;
generating an activation based upon the comparison, wherein the activation defines parameters for sending the correlation information to the subscriber, and wherein the correlation information also includes the strength information.

37. The method of claim 36, wherein the sorting, comparing, and generating operations are repeated from the highest strength information to the lowest strength information.

38. The method of claim 36, wherein the sorting, comparing, and generating operations are at least partially performed according to a Dijkstra algorithm.

39. The method of claim 36, further comprising:
receiving a threshold limit from the subscriber;
comparing the first or second strength information with the threshold limit; and
transmitting the correlation information to the subscriber if the first or second strength information exceeds the threshold limit.

40. The method of claim 1, wherein the correlation results in the generation of a data set that represents the intersection of the association information, the preference information, and the first entity information.

41. The method of claim 1, further comprising:
generating strength adjustment information concerning selections or inspections made by the subscriber of objects within at least one of the association information and the preference information; and
updating the first or second strength information based upon the strength adjustment information.

42. The method of claim 1, further comprising:
centile ranking of at least one of the association information and the preference information based at least upon at least one of the first and second strength information.

43. The method of claim 1, further comprising:
Bayesian statistical analysis of at least one of the association information and the preference information based on key words related to the association information and the preference information.

44. The method of claim 1, further comprising:
receiving time information; and
assessing the time information in connection with the correlation before generating the correlation information.

45. The method of claim 1, wherein at least one of the association information and the preference information is limited by the current locus.

46. The method of claim 1, further comprising:
establishing a garbage threshold for the subscriber;
comparing the first or second strength information with the garbage threshold; and
removing selected association or preference information from the correlation, if the first or second strength information falls below the garbage threshold.

47. The method of claim 1, further comprising:
establishing a garbage threshold for the subscriber;
comparing the first or second strength information with the garbage threshold; and
deleting association or preference information from the subscriber, if the first or second strength information falls below the garbage threshold.

48. The method of claim 46, wherein the comparison of the first or second strength information with the garbage threshold is performed via centile ranking.

49. The method of claim 41, further comprising:
receiving a drag factor;
generating the strength adjustment information with reference to the drag factor; and
updating the first or second strength information related to at least one of the association information and the preference information based upon the strength adjustment information,
wherein the drag factor limits the extent to which the first and second strength information are updated by the strength adjustment information.

50. The method of claim 44, further comprising:
computing status information with respect to the subscriber, wherein the status information at least encompasses a prior history of the subscriber with respect to the association information, the preference information, and the time; and
automatically initiating a search for the group of first entities based at least on the status information and the time.

51. The method of claim 1, further comprising:
receiving an indication that at least one from the group of first entities has entered the current locus of the subscriber; and
automatically initiating correlation in response to the indication that the at least one from the group of first entities has entered the current locus of the subscriber.

52. The method of claim 1, further comprising:
evaluating the second strength information;
if the magnitude of the second strength information exceeds a predetermined strength threshold, modifying the preference information to include a parameter encompassing the association information.

53. The method of claim 1, wherein the processor is a multithreaded processor with each of a plurality of threads being dedicated at least one of the subscriber and at least one from the group of first entities.

54. An architecture for automated interaction between subscribers, comprising:
a location server associated with a location comprising at least one of a geographic area, a non-geographic area, and a virtual locational space, wherein the location server determines a subscriber's proximity to the location and generates location information; and
an inference server in communication with the location server, wherein the inference server receives subscriber objects from the subscriber, creates a set of activation objects based on the location information and the subscriber objects, and identifies at least some of the activation objects to the subscriber, wherein the activation objects are generated based on a statistical inference between the location information and the subscriber objects and reflects a relevance of selected information to the subscriber.

55. The architecture of claim 54, wherein the inference server also receives preference information from the subscriber and generates the set of activation objects based on the preference information.

56. An apparatus for automated interaction between a subscriber and at least one entity, comprising:
a detector to detect location information about a subscriber, wherein the location information comprises at least one of a geographic area, a non-geographic area, and a virtual locational space;
a receiver to receive first information from a subscriber comprising association information, preference information, and strength information, wherein the strength information related to the association information and the preference information and indicates a magnitude of the subscriber's respective preference for the association information and the preference information;
a processor to correlate the strength information with information from an entity, wherein the entity is disposed in or near the location, and to generate second information based on the correlation; and
a transmitter to transmit the second information to the subscriber for display to the subscriber.
